(19) United States
(12) Patent Application Publication
(10) Pub. No.: US 2025/0365664 A1
(43) Pub. Date: Nov. 27, 2025

(54) ADAPTIVE JITTER INDICATION VIA A WAKEUP SIGNAL

(71) Applicant: QUALCOMM Incorporated, San Diego, CA (US)

(72) Inventors: Huilin XU, Temecula, CA (US); Liangping MA, San Diego, CA (US); Krishna Kiran MUKKAVILLI, San Diego, CA (US); Ahmed ELSHAFIE, San Diego, CA (US); Diana MAAMARI, San Diego, CA (US); Zhichao ZHOU, Beijing (CN); Wanshi CHEN, San Diego, CA (US); Yuchul KIM, San Diego, CA (US); Linhai HE, San Diego, CA (US); Jay Kumar SUNDARARAJAN, San Diego, CA (US); Nicolas CORNILLET, LANNION (FR)

(21) Appl. No.: 18/866,943

(22) PCT Filed: Jul. 30, 2022
(86) PCT No.: PCT/CN2022/109280

§ 371 Date: Nov. 18, 2024

(51) Int. Cl. H04W 52/02; H04W 76/28

(52) U.S. Cl. CPC H04W 52/0235; H04W 76/28

(57) ABSTRACT

Methods, systems, and devices for wireless communications are described. Based on a multi-wakeup signal configuration configured by a network node, a user equipment (UE) may monitor for a first wakeup signal in a first wakeup signal occasion indicating whether to monitor an upcoming on duration of a discontinuous reception (DRX) cycle. Depending on whether the UE detects the first wakeup signal, the UE may monitor for a second wakeup signal in a second wakeup signal occasion indicating a start time of the on duration, or skip monitoring of the on duration. The UE may use different receivers to receive wakeup signals and downlink channels from the network node. The UE may receive a wakeup signal by a first receiver and activate a second receiver to receive a downlink channel, where the UE may store signal samples of the downlink channel in a buffer until the second receiver is fully activated.

### CROSS REFERENCE

The present Application is a 371 national stage filing of International PCT Application No. PCT/CN2022/109280 by XU et al. entitled “ADAPTIVE JITTER INDICATION VIA A WAKEUP SIGNAL,” filed Jul. 30, 2022, which is assigned to the assignee hereof, and which is expressly incorporated by reference in its entirety herein.

### FIELD OF TECHNOLOGY

The following relates to wireless communications, including adaptive jitter indication via a wakeup signal.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

In some wireless communications systems, a UE may receive data that may be subject to random jitter, for example, based on variable data packet sizes. In some cases, however, a network node may transmit mixed traffic to the UE, where some data of the mixed traffic may be subject to jitter more than other data. As such, the UE may continuously monitor for jitter in data regardless of when it is actually being transmitted, thus increasing power consumption.

### SUMMARY

The described techniques relate to improved methods, systems, devices, and apparatuses that support adaptive jitter indication via a wakeup signal. For example, the described techniques provide for a user equipment (UE) to receive wakeup signals from a network node indicating transmissions that may be subject to jitter. In some examples, the network node may configure a multi-wakeup signal configuration indicating a wakeup signal window that includes a first wakeup signal occasion and one or more second wakeup signal occasions. The UE may monitor for a first wakeup signal in the first wakeup signal occasion, and based on whether the UE detects the first wakeup signal, the UE may skip an on duration of a discontinuous reception (DRX) cycle or continue to monitor for a second wakeup signal in one of the second wakeup signal occasions. If the UE monitors for the second wakeup signal, and if data is scheduled to be transmitted to the UE within the on duration of the DRX cycle, the UE may begin monitoring the on duration of the DRX cycle at a start time indicated in the second wakeup signal or a start time that is offset from the second wakeup signal occasion in which the UE detects the second wakeup signal.

In some examples, there may be a time offset between a wakeup signal occasion in which the UE detects a wakeup signal, the wakeup signal indicating that the UE is to receive a downlink channel at some time. To increase power efficiency of wakeup signal detection, the UE may use a first receiver (e.g., a low-power wakeup receiver) for detecting wakeup signals that indicate whether there is data scheduled to be transmitted to the UE during the on duration of the DRX cycle. For example, the UE may use a first receiver to receive a first wakeup signal in the first wakeup signal occasion, the first wakeup signal indicating to activate a second receiver of the UE for detecting data based on the data being scheduled. The UE may store samples of the downlink channel received between a time based on the time offset and a wakeup time of the second receiver, and using the second receiver, the UE may receive the remainder of the downlink channel accordingly.

A method for wireless communication at a UE is described. The method may include receiving control signaling indicating a multi-wakeup signal configuration, the multi-wakeup signal configuration indicating a wakeup signal window, indicating a first wakeup signal occasion within the wakeup signal window that indicates whether to monitor an upcoming on duration of a DRX cycle, and indicating to monitor at least one second wakeup signal occasion within the wakeup signal window when a first wakeup signal is detected in the first wakeup signal occasion, the at least one second wakeup signal occasion indicating a start time of the upcoming on duration of the DRX cycle, monitoring for the first wakeup signal in the first wakeup signal occasion based on the multi-wakeup signal configuration, and monitoring for a second wakeup signal in the at least one second wakeup signal occasion, or skipping monitoring of the upcoming on duration of the DRX cycle, based on monitoring for the first wakeup signal in the first wakeup signal occasion.

An apparatus for wireless communication at a UE is described. The apparatus may include a processor, memory coupled with the processor, and instructions stored in the memory. The instructions may be executable by the processor to cause the apparatus to receive control signaling indicating a multi-wakeup signal configuration, the multi-wakeup signal configuration indicating a wakeup signal window, indicating a first wakeup signal occasion within the wakeup signal window that indicates whether to monitor an upcoming on duration of a DRX cycle, and indicating to monitor at least one second wakeup signal occasion within the wakeup signal window when a first wakeup signal is detected in the first wakeup signal occasion, the at least one second wakeup signal occasion indicating a start time of the upcoming on duration of the DRX cycle, monitor for the first wakeup signal in the first wakeup signal occasion based on the multi-wakeup signal configuration, and monitor for a second wakeup signal in the at least one second wakeup signal occasion, or skipping monitoring of the upcoming on duration of the DRX cycle, based on monitoring for the first wakeup signal in the first wakeup signal occasion.

Another apparatus for wireless communication at a UE is described. The apparatus may include means for receiving control signaling indicating a multi-wakeup signal configuration, the multi-wakeup signal configuration indicating a wakeup signal window, indicating a first wakeup signal occasion within the wakeup signal window that indicates whether to monitor an upcoming on duration of a DRX cycle, and indicating to monitor at least one second wakeup signal occasion within the wakeup signal window when a first wakeup signal is detected in the first wakeup signal occasion, the at least one second wakeup signal occasion indicating a start time of the upcoming on duration of the DRX cycle, means for monitoring for the first wakeup signal in the first wakeup signal occasion based on the multi-wakeup signal configuration, and means for monitoring for a second wakeup signal in the at least one second wakeup signal occasion, or skipping monitoring of the upcoming on duration of the DRX cycle, based on monitoring for the first wakeup signal in the first wakeup signal occasion.

A non-transitory computer-readable medium storing code for wireless communication at a UE is described. The code may include instructions executable by a processor to receive control signaling indicating a multi-wakeup signal configuration, the multi-wakeup signal configuration indicating a wakeup signal window, indicating a first wakeup signal occasion within the wakeup signal window that indicates whether to monitor an upcoming on duration of a DRX cycle, and indicating to monitor at least one second wakeup signal occasion within the wakeup signal window when a first wakeup signal is detected in the first wakeup signal occasion, the at least one second wakeup signal occasion indicating a start time of the upcoming on duration of the DRX cycle, monitor for the first wakeup signal in the first wakeup signal occasion based on the multi-wakeup signal configuration, and monitor for a second wakeup signal in the at least one second wakeup signal occasion, or skipping monitoring of the upcoming on duration of the DRX cycle, based on monitoring for the first wakeup signal in the first wakeup signal occasion.

Some examples of the method, apparatuses, and non-transitory computer-readable medium described herein may further include operations, features, means, or instructions for skipping the monitoring of the upcoming on duration of the DRX cycle based on determining that the first wakeup signal was not detected in the first wakeup signal occasion.

Some examples of the method, apparatuses, and non-transitory computer-readable medium described herein may further include operations, features, means, or instructions for monitoring for the second wakeup signal in the at least one second wakeup signal occasion based on detecting the first wakeup signal in the first wakeup signal occasion.

Some examples of the method, apparatuses, and non-transitory computer-readable medium described herein may further include operations, features, means, or instructions for receiving the second wakeup signal in the at least one second wakeup signal occasion, the second wakeup signal indicating that data may be scheduled to be transmitted to the UE within the upcoming on duration of the DRX cycle.

Some examples of the method, apparatuses, and non-transitory computer-readable medium described herein may further include operations, features, means, or instructions for skipping the monitoring for the second wakeup signal in one or more remaining second wakeup signal occasions in the wakeup signal window based on detecting the second wakeup signal in the at least one second wakeup signal occasion.

Some examples of the method, apparatuses, and non-transitory computer-readable medium described herein may further include operations, features, means, or instructions for monitoring the upcoming on duration of the DRX cycle based on the start time of the upcoming on duration of the DRX cycle indicated in the second wakeup signal.

Some examples of the method, apparatuses, and non-transitory computer-readable medium described herein may further include operations, features, means, or instructions for monitoring the upcoming on duration of the DRX cycle at the start time of the upcoming on duration of the DRX cycle corresponding to a time offset with respect to the at least one second wakeup signal occasion in which the UE detects the second wakeup signal.

In some examples of the method, apparatuses, and non-transitory computer-readable medium described herein, the first wakeup signal occasion and the at least one second wakeup signal occasion at least partially overlap in time, in frequency, or both.

In some examples of the method, apparatuses, and non-transitory computer-readable medium described herein, one or more sequences may be associated with the first wakeup signal, the second wakeup signal, or both.

In some examples of the method, apparatuses, and non-transitory computer-readable medium described herein, one or more signaling types may be associated with the first wakeup signal, the second wakeup signal, or both.

In some examples of the method, apparatuses, and non-transitory computer-readable medium described herein, one or more resource allocations may be associated with the first wakeup signal, the second wakeup signal, or both.

In some examples of the method, apparatuses, and non-transitory computer-readable medium described herein, one or more modulations may be associated with the first wakeup signal, the second wakeup signal, or both.

A method for wireless communication at a UE is described. The method may include transmitting a control message indicating a first time offset between a wakeup signal occasion and a downlink channel, receiving, by a first receiver of the UE, a first wakeup signal in a first wakeup signal occasion that indicates to activate a second receiver of the UE, storing signal samples of the downlink channel that are to be processed by the second receiver, where a first portion of the downlink channel occurs between a first time that is offset in time relative to the first wakeup signal occasion and a wakeup time of the second receiver, and receiving, by the second receiver and after the wakeup time, a remainder of the downlink channel.

An apparatus for wireless communication at a UE is described. The apparatus may include a processor, memory coupled with the processor, and instructions stored in the memory. The instructions may be executable by the processor to cause the apparatus to transmit a control message indicating a first time offset between a wakeup signal occasion and a downlink channel, receive, by a first receiver of the UE, a first wakeup signal in a first wakeup signal occasion that indicates to activate a second receiver of the UE, store signal samples of the downlink channel that are to be processed by the second receiver, where a first portion of the downlink channel occurs between a first time that is offset in time relative to the first wakeup signal occasion and a wakeup time of the second receiver, and receive, by the second receiver and after the wakeup time, a remainder of the downlink channel.

Another apparatus for wireless communication at a UE is described. The apparatus may include means for transmitting a control message indicating a first time offset between a wakeup signal occasion and a downlink channel, means for receiving, by a first receiver of the UE, a first wakeup signal in a first wakeup signal occasion that indicates to activate a second receiver of the UE, means for storing signal samples of the downlink channel that are to be processed by the second receiver, where a first portion of the downlink channel occurs between a first time that is offset in time relative to the first wakeup signal occasion and a wakeup time of the second receiver, and means for receiving, by the second receiver and after the wakeup time, a remainder of the downlink channel.

A non-transitory computer-readable medium storing code for wireless communication at a UE is described. The code may include instructions executable by a processor to transmit a control message indicating a first time offset between a wakeup signal occasion and a downlink channel, receive, by a first receiver of the UE, a first wakeup signal in a first wakeup signal occasion that indicates to activate a second receiver of the UE, store signal samples of the downlink channel that are to be processed by the second receiver, where a first portion of the downlink channel occurs between a first time that is offset in time relative to the first wakeup signal occasion and a wakeup time of the second receiver, and receive, by the second receiver and after the wakeup time, a remainder of the downlink channel.

In some examples of the method, apparatuses, and non-transitory computer-readable medium described herein, transmitting the control message may include operations, features, means, or instructions for transmitting the control message indicating the first time offset that may be a reference time offset associated with a reference bandwidth, where the first portion of the downlink channel occurs between the first time that may be offset in time by a second time offset relative to the first wakeup signal occasion and the wakeup time of the second receiver, the second time offset based on an active bandwidth of the downlink channel, the reference time offset, and the reference bandwidth.

In some examples of the method, apparatuses, and non-transitory computer-readable medium described herein, transmitting the control message may include operations, features, means, or instructions for transmitting the control message indicating a set of multiple time offsets associated with respective reference bandwidths, the set of multiple time offsets including the first time offset, where the first portion of the downlink channel occurs between the first time that may be offset in time by a second time offset relative to the first wakeup signal occasion and the wakeup time of the second receiver, where the second time offset corresponds to one of the set of multiple time offsets.

In some examples of the method, apparatuses, and non-transitory computer-readable medium described herein, the second time offset corresponds to a smallest reference bandwidth of the respective reference bandwidths that may be larger than an active bandwidth of the downlink channel.

In some examples of the method, apparatuses, and non-transitory computer-readable medium described herein, transmitting the control message may include operations, features, means, or instructions for transmitting the control message indicating the time offset that corresponds to an active bandwidth of the downlink channel.

In some examples of the method, apparatuses, and non-transitory computer-readable medium described herein, the control message includes UE capability signaling or UE assistance information (UAI).

A method for wireless communication at a network node is described. The method may include transmitting control signaling indicating a multi-wakeup signal configuration, the multi-wakeup signal configuration indicating a wakeup signal window, indicating a first wakeup signal occasion within the wakeup signal window that indicates whether to monitor an upcoming on duration of a DRX cycle, and indicating to monitor at least one second wakeup signal occasion within the wakeup signal window when a first wakeup signal is detected in the first wakeup signal occasion, the at least one second wakeup signal occasion indicating a start time of the upcoming on duration of the DRX cycle, transmitting the first wakeup signal in the first wakeup signal occasion based on the multi-wakeup signal configuration, and transmitting a second wakeup signal in the at least one second wakeup signal occasion based on the multi-wakeup signal configuration.

An apparatus for wireless communication at a network node is described. The apparatus may include a processor, memory coupled with the processor, and instructions stored in the memory. The instructions may be executable by the processor to cause the apparatus to transmit control signaling indicating a multi-wakeup signal configuration, the multi-wakeup signal configuration indicating a wakeup signal window, indicating a first wakeup signal occasion within the wakeup signal window that indicates whether to monitor an upcoming on duration of a DRX cycle, and indicating to monitor at least one second wakeup signal occasion within the wakeup signal window when a first wakeup signal is detected in the first wakeup signal occasion, the at least one second wakeup signal occasion indicating a start time of the upcoming on duration of the DRX cycle, transmit the first wakeup signal in the first wakeup signal occasion based on the multi-wakeup signal configuration, and transmit a second wakeup signal in the at least one second wakeup signal occasion based on the multi-wakeup signal configuration.

Another apparatus for wireless communication at a network node is described. The apparatus may include means for transmitting control signaling indicating a multi-wakeup signal configuration, the multi-wakeup signal configuration indicating a wakeup signal window, indicating a first wakeup signal occasion within the wakeup signal window that indicates whether to monitor an upcoming on duration of a DRX cycle, and indicating to monitor at least one second wakeup signal occasion within the wakeup signal window when a first wakeup signal is detected in the first wakeup signal occasion, the at least one second wakeup signal occasion indicating a start time of the upcoming on duration of the DRX cycle, means for transmitting the first wakeup signal in the first wakeup signal occasion based on the multi-wakeup signal configuration, and means for transmitting a second wakeup signal in the at least one second wakeup signal occasion based on the multi-wakeup signal configuration.

A non-transitory computer-readable medium storing code for wireless communication at a network node is described. The code may include instructions executable by a processor to transmit control signaling indicating a multi-wakeup signal configuration, the multi-wakeup signal configuration indicating a wakeup signal window, indicating a first wakeup signal occasion within the wakeup signal window that indicates whether to monitor an upcoming on duration of a DRX cycle, and indicating to monitor at least one second wakeup signal occasion within the wakeup signal window when a first wakeup signal is detected in the first wakeup signal occasion, the at least one second wakeup signal occasion indicating a start time of the upcoming on duration of the DRX cycle, transmit the first wakeup signal in the first wakeup signal occasion based on the multi-wakeup signal configuration, and transmit a second wakeup signal in the at least one second wakeup signal occasion based on the multi-wakeup signal configuration.

In some examples of the method, apparatuses, and non-transitory computer-readable medium described herein, transmitting the second wakeup signal may include operations, features, means, or instructions for transmitting the second wakeup signal in the at least one second wakeup signal occasion based on transmitting the first wakeup signal in the first wakeup signal occasion.

In some examples of the method, apparatuses, and non-transitory computer-readable medium described herein, transmitting the second wakeup signal may include operations, features, means, or instructions for transmitting the second wakeup signal in the at least one second wakeup signal occasion, the second wakeup signal indicating that data that may be scheduled to be transmitted to a UE within the upcoming on duration of the DRX cycle.

In some examples of the method, apparatuses, and non-transitory computer-readable medium described herein, the start time of the upcoming on duration of the DRX cycle may be indicated in the second wakeup signal.

In some examples of the method, apparatuses, and non-transitory computer-readable medium described herein, the start time of the upcoming on duration of the DRX cycle corresponds to a time offset with respect to the at least one second wakeup signal occasion.

In some examples of the method, apparatuses, and non-transitory computer-readable medium described herein, the first wakeup signal occasion and the at least one second wakeup signal occasion at least partially overlap in time, in frequency, or both.

In some examples of the method, apparatuses, and non-transitory computer-readable medium described herein, one or more sequences may be associated with the first wakeup signal, the second wakeup signal, or both.

In some examples of the method, apparatuses, and non-transitory computer-readable medium described herein, one or more signaling types may be associated with the first wakeup signal, the second wakeup signal, or both.

In some examples of the method, apparatuses, and non-transitory computer-readable medium described herein, one or more resource allocations may be associated with the first wakeup signal, the second wakeup signal, or both.

In some examples of the method, apparatuses, and non-transitory computer-readable medium described herein, one or more modulations may be associated with the first wakeup signal, the second wakeup signal, or both.

### BRIEF DESCRIPTION OF THE DRAWINGS

FIG. 1 illustrates an example of a wireless communications system that supports adaptive jitter indication via a wakeup signal in accordance with one or more aspects of the present disclosure.

FIG. 2 illustrates an example of a wireless communications system that supports adaptive jitter indication via a wakeup signal in accordance with one or more aspects of the present disclosure.

FIG. 3 illustrates an example of a transmission scheme that supports adaptive jitter indication via a wakeup signal in accordance with one or more aspects of the present disclosure.

FIGS. 4 through 6 illustrate examples of process flows that support adaptive jitter indication via a wakeup signal in accordance with one or more aspects of the present disclosure.

FIGS. 7 and 8 show block diagrams of devices that support adaptive jitter indication via a wakeup signal in accordance with one or more aspects of the present disclosure.

FIG. 9 shows a block diagram of a communications manager that supports adaptive jitter indication via a wakeup signal in accordance with one or more aspects of the present disclosure.

FIG. 10 shows a diagram of a system including a device that supports adaptive jitter indication via a wakeup signal in accordance with one or more aspects of the present disclosure.

FIGS. 11 and 12 show block diagrams of devices that support adaptive jitter indication via a wakeup signal in accordance with one or more aspects of the present disclosure.

FIG. 13 shows a block diagram of a communications manager that supports adaptive jitter indication via a wakeup signal in accordance with one or more aspects of the present disclosure.

FIG. 14 shows a diagram of a system including a device that supports adaptive jitter indication via a wakeup signal in accordance with one or more aspects of the present disclosure.

FIGS. 15 through 20 show flowcharts illustrating methods that support adaptive jitter indication via a wakeup signal in accordance with one or more aspects of the present disclosure.

### DETAILED DESCRIPTION

Some wireless communications between a user equipment (UE) and a network node may include jitter. For example, the UE and the network node may communicate extended reality (XR) video frame data (e.g., virtual reality (VR) data, augmented reality (AR) data, mixed reality (MR) data, and other types of data which may be associated with high reliability and low latency transmissions). In some examples, arrival times of the XR video frame data at a wireless device may be subject to random jitter, for example, based on variable sizes of XR video frames. However, behavior of the UE may change if the network node transmits mixed traffic that includes XR video frame data and other traffic. For example, in a given connected mode discontinuous reception (CDRX) cycle, the UE may receive some traffic with or without XR video frame data, where the XR video frame data may be subject to more jitter than other types of traffic.

In some examples, the network node may transmit one or more wakeup signals to the UE indicating whether there may be data for the UE to receive in an on duration of a DRX cycle that is associated with jitter. The UE may monitor for the wakeup signals in a wakeup signal monitoring window that covers at least a portion of a jitter range (e.g., a portion of the DRX cycle in which the network node may transmit data subject to jitter). However, a wakeup signal monitoring window that covers an entire jitter range may result in increased power consumption at the UE as the UE is continuously monitoring for data, and a wakeup signal monitoring window that covers a portion of the jitter range may result in delays to reception of the data at the UE as the data may arrive outside of the wakeup signal monitoring window.

The techniques described herein support adaptive jitter indication using wakeup signals, where a UE may receive wakeup signals from a network node indicating transmissions (e.g., XR video traffic) that may be subject to jitter. In some examples, the network node may configure a multi-wakeup signal configuration indicating a wakeup signal window that includes a first wakeup signal occasion and one or more second wakeup signal occasions. In some examples, the network node may transmit wakeup signals in the first wakeup signal occasion, one or more of the second wakeup signal occasions, or a combination thereof based on different parameters associated with the wakeup signals (e.g., sequences, signaling types, resource allocations, modulations, and the like). The UE may monitor for a first wakeup signal in the first wakeup signal occasion, and based on whether the UE detects the first wakeup signal, the UE may skip an on duration of a DRX cycle or continue to monitor for a second wakeup signal in one of the second wakeup signal occasions. If the UE monitors for the second wakeup signal, and if data is scheduled to be transmitted to the UE within the on duration of the DRX cycle, the UE may begin monitoring the on duration of the DRX cycle at a start time indicated in the second wakeup signal or a start time that is offset from the second wakeup signal occasion in which the UE detects the second wakeup signal.

In some examples, there may be a time offset between a wakeup signal occasion in which the UE detects a wakeup signal, the wakeup signal indicating that the UE is to receive a downlink channel at some time. To increase power efficiency of wakeup signal detection, the UE may use a first receiver (e.g., a low-power wakeup receiver) for detecting wakeup signals that indicate whether there is data scheduled to be transmitted to the UE during the on duration of the DRX cycle. For example, the UE may use a first receiver to receive a first wakeup signal in the first wakeup signal occasion, the first wakeup signal indicating to activate a second receiver of the UE for detecting data based on the data being scheduled. The UE may store samples of the downlink channel received between a time based on the time offset and a wakeup time of the second receiver, and using the second receiver, the UE may receive the remainder of the downlink channel accordingly.

Aspects of the disclosure are initially described in the context of wireless communications systems. Aspects of the disclosure are then described in the context of transmission schemes and process flows. Aspects of the disclosure are further illustrated by and described with reference to apparatus diagrams, system diagrams, and flowcharts that relate to adaptive jitter indication via a wakeup signal.

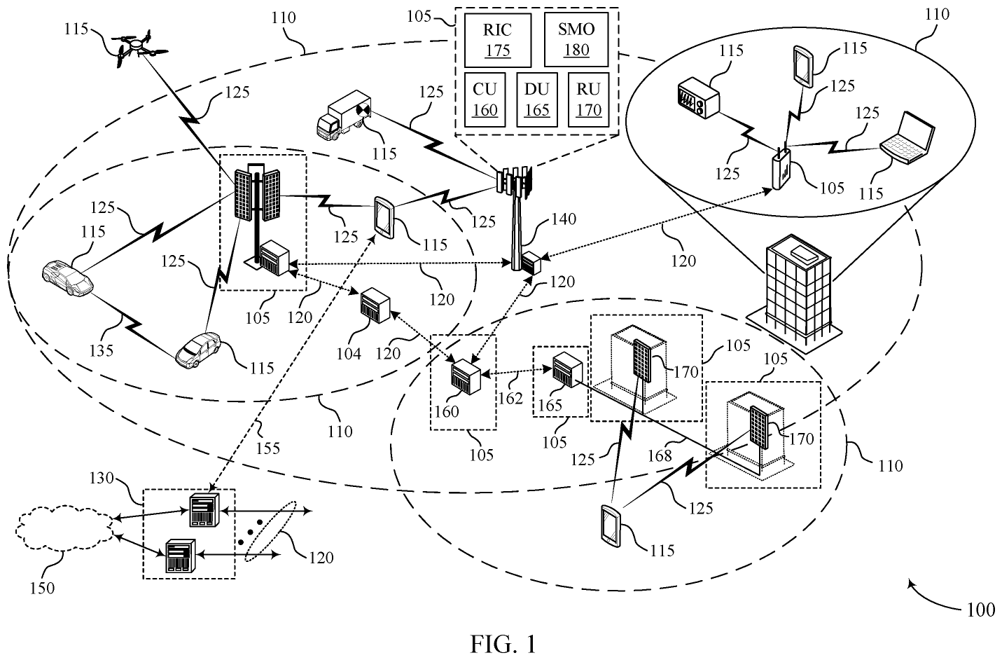

FIG. 1 illustrates an example of a wireless communications system 100 that supports adaptive jitter indication via a wakeup signal in accordance with one or more aspects of the present disclosure. The wireless communications system 100 may include one or more network entities 105, one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via one or more communication links 125 (e.g., a radio frequency (RF) access link). For example, a network entity 105 may support a coverage area 110 (e.g., a geographic coverage area) over which the UEs 115 and the network entity 105 may establish one or more communication links 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices, such as other UEs 115 or network entities 105, as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with the core network 130, or with one another, or both. For example, network entities 105 may communicate with the core network 130 via one or more backhaul communication links 120 (e.g., in accordance with an S1, N2, N3, or other interface protocol). In some examples, network entities 105 may communicate with one another via a backhaul communication link 120 (e.g., in accordance with an X2, Xn, or other interface protocol) either directly (e.g., directly between network entities 105) or indirectly (e.g., via a core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication links 120, midhaul communication links 162, or fronthaul communication links 168 may be or include one or more wired links (e.g., an electrical link, an optical fiber link), one or more wireless links (e.g., a radio link, a wireless optical link), among other examples or various combinations thereof. A UE 115 may communicate with the core network 130 via a communication link 155.

One or more of the network entities 105 described herein may include or may be referred to as a base station 140 (e.g., a base transceiver station, a radio base station, an NR base station, an access point, a radio transceiver, a NodeB, an eNodeB (eNB), a next-generation NodeB or a giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within a single network entity 105 (e.g., a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among two or more network entities 105, such as an integrated access backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU) 160, a distributed unit (DU) 165, a radio unit (RU) 170, a RAN Intelligent Controller (RIC) 175 (e.g., a Near-Real Time RIC (Near-RT RIC), a Non-Real Time RIC (Non-RT RIC)), a Service Management and Orchestration (SMO) 180 system, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, and any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaption protocol (SDAP), Packet Data Convergence Protocol (PDCP)). The CU 160 may be connected to one or more DUs 165 or RUs 170, and the one or more DUs 165 or RUs 170 may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or more RUs 170). In some cases, a functional split between a CU 160 and a DU 165, or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to one or more DUs 165 via a midhaul communication link 162 (e.g., F1, F1-c, F1-u), and a DU 165 may be connected to one or more RUs 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities 105 that are in communication via such communication links.

In wireless communications systems (e.g., wireless communications system 100), infrastructure and spectral resources for radio access may support wireless backhaul link capabilities to supplement wired backhaul connections, providing an IAB network architecture (e.g., to a core network 130). In some cases, in an IAB network, one or more network entities 105 (e.g., IAB nodes 104) may be partially controlled by each other. One or more IAB nodes 104 may be referred to as a donor entity or an IAB donor. One or more DUs 165 or one or more RUs 170 may be partially controlled by one or more CUs 160 associated with a donor network entity 105 (e.g., a donor base station 140). The one or more donor network entities 105 (e.g., IAB donors) may be in communication with one or more additional network entities 105 (e.g., IAB nodes 104) via supported access and backhaul links (e.g., backhaul communication links 120). IAB nodes 104 may include an IAB mobile termination (IAB-MT) controlled (e.g., scheduled) by DUs 165 of a coupled IAB donor. An IAB-MT may include an independent set of antennas for relay of communications with UEs 115, or may share the same antennas (e.g., of an RU 170) of an IAB node 104 used for access via the DU 165 of the IAB node 104 (e.g., referred to as virtual IAB-MT (vIAB-MT)). In some examples, the IAB nodes 104 may include DUs 165 that support communication links with additional entities (e.g., IAB nodes 104, UEs 115) within the relay chain or configuration of the access network (e.g., downstream). In such cases, one or more components of the disaggregated RAN architecture (e.g., one or more IAB nodes 104 or components of IAB nodes 104) may be configured to operate according to the techniques described herein.

In the case of the techniques described herein applied in the context of a disaggregated RAN architecture, one or more components of the disaggregated RAN architecture may be configured to support adaptive jitter indication via a wakeup signal as described herein. For example, some operations described as being performed by a UE 115 or a network entity 105 (e.g., a base station 140) may additionally, or alternatively, be performed by one or more components of the disaggregated RAN architecture (e.g., IAB nodes 104, DUs 165, CUs 160, RUs 170, RIC 175, SMO 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via one or more communication links 125 (e.g., an access link) using resources associated with one or more carriers. The term “carrier” may refer to a set of RF spectrum resources having a defined physical layer structure for supporting the communication links 125. For example, a carrier used for a communication link 125 may include a portion of a RF spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities 105).

A carrier may be associated with a particular bandwidth of the RF spectrum and, in some examples, the carrier bandwidth may be referred to as a “system bandwidth” of the carrier or the wireless communications system 100. For example, the carrier bandwidth may be one of a set of bandwidths for carriers of a particular radio access technology (e.g., 1.4, 3, 5, 10, 15, 20, 40, or 80 megahertz (MHz)). Devices of the wireless communications system 100 (e.g., the network entities 105, the UEs 115, or both) may have hardware configurations that support communications using a particular carrier bandwidth or may be configurable to support communications using one of a set of carrier bandwidths. In some examples, the wireless communications system 100 may include network entities 105 or UEs 115 that support concurrent communications using carriers associated with multiple carrier bandwidths. In some examples, each served UE 115 may be configured for operating using portions (e.g., a sub-band, a BWP) or all of a carrier bandwidth.

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

One or more numerologies for a carrier may be supported, and a numerology may include a subcarrier spacing (Δf) and a cyclic prefix. A carrier may be divided into one or more BWPs having the same or different numerologies. In some examples, a UE 115 may be configured with multiple BWPs. In some examples, a single BWP for a carrier may be active at a given time and communications for the UE 115 may be restricted to one or more active BWPs.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (STTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

In some examples, a network entity 105 (e.g., a base station 140, an RU 170) may be movable and therefore provide communication coverage for a moving coverage area 110. In some examples, different coverage areas 110 associated with different technologies may overlap, but the different coverage areas 110 may be supported by the same network entity 105. In some other examples, the overlapping coverage areas 110 associated with different technologies may be supported by different network entities 105. The wireless communications system 100 may include, for example, a heterogeneous network in which different types of the network entities 105 provide coverage for various coverage areas 110 using the same or different radio access technologies.

Some UEs 115, such as MTC or IoT devices, may be low cost or low complexity devices and may provide for automated communication between machines (e.g., via Machine-to-Machine (M2M) communication). M2M communication or MTC may refer to data communication technologies that allow devices to communicate with one another or a network entity 105 (e.g., a base station 140) without human intervention. In some examples, M2M communication or MTC may include communications from devices that integrate sensors or meters to measure or capture information and relay such information to a central server or application program that uses the information or presents the information to humans interacting with the application program. Some UEs 115 may be designed to collect information or enable automated behavior of machines or other devices. Examples of applications for MTC devices include smart metering, inventory monitoring, water level monitoring, equipment monitoring, healthcare monitoring, wildlife monitoring, weather and geological event monitoring, fleet management and tracking, remote security sensing, physical access control, and transaction-based business charging.

Some UEs 115 may be configured to employ operating modes that reduce power consumption, such as half-duplex communications (e.g., a mode that supports one-way communication via transmission or reception, but not transmission and reception concurrently). In some examples, half-duplex communications may be performed at a reduced peak rate. Other power conservation techniques for the UEs 115 include entering a power saving deep sleep mode when not engaging in active communications, operating using a limited bandwidth (e.g., according to narrowband communications), or a combination of these techniques. For example, some UEs 115 may be configured for operation using a narrowband protocol type that is associated with a defined portion or range (e.g., set of subcarriers or resource blocks (RBs)) within a carrier, within a guard-band of a carrier, or outside of a carrier.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs 115 via a device-to-device (D2D) communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to each of the other UEs 115 in the group. In some examples, a network entity 105 may facilitate the scheduling of resources for D2D communications. In some other examples, D2D communications may be carried out between the UEs 115 without an involvement of a network entity 105.

In some systems, a D2D communication link 135 may be an example of a communication channel, such as a sidelink communication channel, between vehicles (e.g., UEs 115). In some examples, vehicles may communicate using vehicle-to-everything (V2X) communications, vehicle-to-vehicle (V2V) communications, or some combination of these. A vehicle may signal information related to traffic conditions, signal scheduling, weather, safety, emergencies, or any other information relevant to a V2X system. In some examples, vehicles in a V2X system may communicate with roadside infrastructure, such as roadside units, or with the network via one or more network nodes (e.g., network entities 105, base stations 140, RUs 170) using vehicle-to-network (V2N) communications, or with both.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than 100 kilometers) compared to communications using the smaller frequencies and longer waves of the high frequency (HF) or very high frequency (VHF) portion of the spectrum below 300 MHz.

The wireless communications system 100 may also operate using a super high frequency (SHF) region, which may be in the range of 3 GHz to 30 GHz, also known as the centimeter band, or using an extremely high frequency (EHF) region of the spectrum (e.g., from 30 GHz to 300 GHz), also known as the millimeter band. In some examples, the wireless communications system 100 may support millimeter wave (mmW) communications between the UEs 115 and the network entities 105 (e.g., base stations 140, RUs 170), and EHF antennas of the respective devices may be smaller and more closely spaced than UHF antennas. In some examples, such techniques may facilitate using antenna arrays within a device. The propagation of EHF transmissions, however, may be subject to even greater attenuation and shorter range than SHF or UHF transmissions. The techniques disclosed herein may be employed across transmissions that use one or more different frequency regions, and designated use of bands across these frequency regions may differ by country or regulating body.

The wireless communications system 100 may utilize both licensed and unlicensed RF spectrum bands. For example, the wireless communications system 100 may employ License Assisted Access (LAA), LTE-Unlicensed (LTE-U) radio access technology, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

Some UEs 115 and network nodes 105 may communicate transmissions that are subject to random jitter. For example, XR data may include VR data, AR data, MR data, and other types of data that may be associated with high reliability and low latency transmissions may be associated with jitter. For example, a network node 105 may transmit XR video frame data to UEs 115 (e.g., XR users, XR devices, or other devices that support XR communications), where variable frame sizes of XR video frame data may cause jitter in the transmissions. In some cases, a particular delay between an arrival time of the XR video frame data at a UE 115 and a decoding of the XR video frame data at the UE 115 may result in jitter. In some examples, the arrival time of the XR video frame data may be subject to random jitter that follows a truncated Gaussian distribution having a mean of zero, a standard deviation of 2 ms, and a range of [−4, 4] ms. For example, AR or VR data of 30 Mbps may have a minimum packet size of 31,250 bytes, a maximum packet size of 93,750 bytes, and a mean packet size of 62,500 bytes, which may require 5 slots, 10 slots and 15 slots, respectively, for a 100 MHz bandwidth, a 30 kHz subcarrier spacing, a 16 quadrature amplitude modulation (QAM), and a ⅓ code rate. In addition, there may be a limited delay budget for the XR video frame data. For example, for AR or VR data, the delay budget may be 10 ms from the time the data arrives at the network node 105 to the time the data is successfully transferred to the UE 115.

In some examples, the network node 105 may transmit mixed traffic to the UE 115 that includes XR video frame data and some other traffic. In a given CDRX cycle, the UE 115 may receive some data with or without XR video frame data. Additionally, the UE 115 may consider jitter for the XR video frame data more than for other types of traffic. As such, the UE 115 may be unaware of the timing of the jitter and thus may monitor physical downlink control channel (PDCCH) transmissions from the network node 105 in each slot to detect XR video frame data or other downlink transmissions having jitter. Because the jitter may occur during a wide range of a DRX cycle, it may be inefficient for the UE 115 to continuously monitor for the jitter. As such, the UE 115 may improve detection of jitter in XR and other data transmissions based on some dynamic signaling (e.g., a wakeup signal, scheduling downlink control information (DCI), and the like) transmitted from the network node 105.

The network node 105 may transmit a wakeup signal to the UE 115 during one or more wakeup signal occasions within a wakeup signal monitoring window, where a wakeup signal may indicate whether there is data for the UE 115 to receive in an on duration of a DRX cycle that may be subject to jitter. To ensure that the UE 115 receives the data transmitted from the network node 105 within a current DRX cycle, the network node 105 may configure the wakeup signal monitoring window to cover at least a later half of a jitter range (of the DRX cycle). For example, the network node 105 may configure the wakeup signal monitoring window to cover the entire jitter range of the DRX cycle such that the UE 115 may be notified of any jitter that may occur during that jitter range. Alternatively, the network node 105 may configure the wakeup signal monitoring window to cover a partial jitter range (e.g., a second half of the partial jitter range of the DRX cycle), which may introduce a delay in the reception of XR video frame data as the UE 115 may refrain from detecting jitter in a first half of the jitter range.

In some other examples, the network node 105 may configure the wakeup signal monitoring window to cover particular slots or shorter portions of the jitter range in the DRX cycle. Using such a wakeup signal monitoring window, if upcoming data transmissions include jitter, the network node 105 may transmit a wakeup signal as early as possible to indicate whether the UE 115 may receive the XR video frame data. If the upcoming data transmissions lack jitter, the UE 115 may monitor the wakeup signal once in the sparse wakeup signal monitoring window even though there are multiple wakeup signal occasions in the wakeup signal monitoring window. However, the sparse wakeup signaling monitoring window may create delays in XR video reception in some cases, and may result in inefficient monitoring as the granularity at which the UE 115 monitors for jitter increases.

The wireless communications system 100 may support adaptive jitter indication via a wakeup signal, which may support decreased latency and decreased power consumption for a UE 115. For example, a network node 105 may transmit one or more wakeup signals to the UE 115 indicating future data transmissions (e.g., XR video frame data) subject to jitter, which may result in XR transmission-specific power savings that accommodate some characteristics of XR data transmissions (e.g., periodicity, multiple flows, jitter, latency, reliability). In some examples, the wakeup signal may enable the UE 115 to more efficiently monitor CDRX cycles and PDCCH transmissions for data that may be subject to jitter.

In some examples, a UE 115 may receive wakeup signals from a network node 105 indicating transmissions (e.g., XR video traffic) that may be subject to jitter. In some examples, the network node 105 may configure a multi-wakeup signal configuration indicating a wakeup signal window that includes a first wakeup signal occasion and one or more second wakeup signal occasions. In some examples, the network node 105 may transmit wakeup signals in the first wakeup signal occasion, one or more of the second wakeup signal occasions, or a combination thereof based on different parameters associated with the wakeup signals (e.g., sequences, signaling types, resource allocations, modulations, and the like). The UE 115 may monitor for a first wakeup signal in the first wakeup signal occasion, and based on whether the UE 115 detects the first wakeup signal, the UE 115 may skip an on duration of a DRX cycle or continue to monitor for a second wakeup signal in one of the second wakeup signal occasions. If the UE 115 monitors for the second wakeup signal, and if data is scheduled to be transmitted to the UE 115 within the on duration of the DRX cycle, the UE 115 may begin monitoring the on duration of the DRX cycle at a start time indicated in the second wakeup signal or a start time that is offset from the second wakeup signal occasion in which the UE 115 detects the second wakeup signal.

In some examples, there may be a time offset between a wakeup signal occasion in which the UE 115 detects a wakeup signal, the wakeup signal indicating that the UE 115 is to receive a downlink channel at some time. To increase power efficiency of wakeup signal detection, the UE 115 may use a first receiver (e.g., a low-power wakeup receiver) for detecting wakeup signals that indicate whether there is data scheduled to be transmitted to the UE 115 during the on duration of the DRX cycle. For example, the UE 115 may use a first receiver to receive a first wakeup signal in the first wakeup signal occasion, the first wakeup signal indicating to activate a second receiver of the UE 115 for detecting data based on the data being scheduled. The UE 115 may store samples of the downlink channel received between a time based on the time offset and a wakeup time of the second receiver, and using the second receiver, the UE 115 may receive the remainder of the downlink channel accordingly.

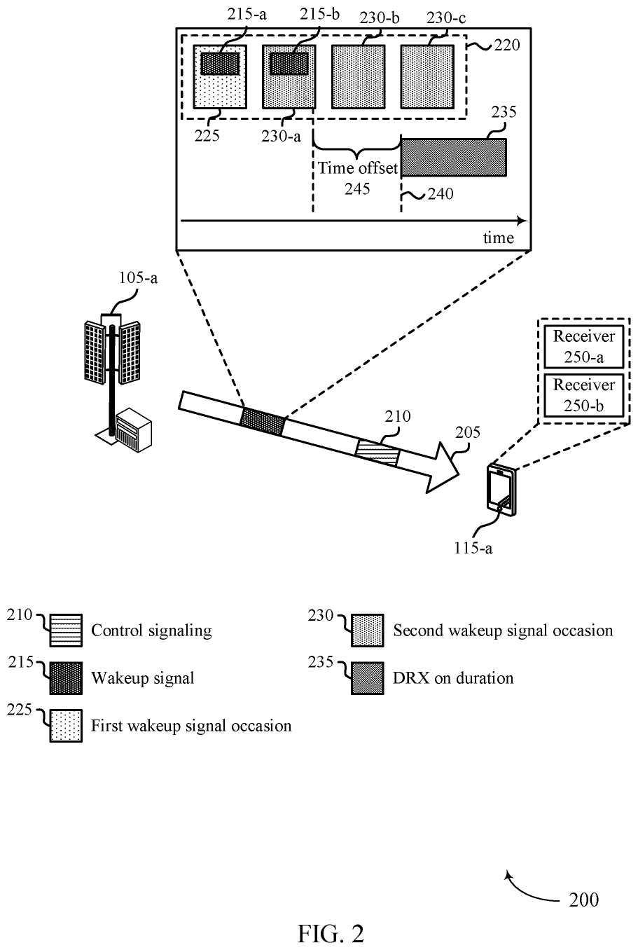

FIG. 2 illustrates an example of a wireless communications system 200 that supports adaptive jitter indication via a wakeup signal in accordance with one or more aspects of the present disclosure. In some examples, the wireless communications system 200 may implement aspects of the wireless communications system 100 or may be implemented by aspects of the wireless communications system 100. For example, the wireless communications system 200 may include a UE 115-a and a network node 105-a (e.g., a network entity), which may be examples of corresponding devices as described herein. In some examples, the wireless communications system 200 may support a multi-wakeup signal configuration for the UE 115-a and the network node 105-a, which the UE 115-a may use in wakeup signal detection to determine whether to skip an upcoming DRX on duration or continue performing wakeup signal detection.

The wireless communications system 200 may support communications between the UE 115-a and the network node 105-a. For example, the UE 115-a may receive downlink transmissions from the network node 105-a via a communication link 205, which may be an example of a communication link 125 described with reference to FIG. 1. The UE 115-a may support a receiver 250-a (e.g., a first receiver) and a receiver 250-b (e.g., a second receiver), which may be dedicated to receiving different signaling types. For example, the receiver 250-a may be a low-power wakeup receiver, which the UE 115-c may use to detect and receive wakeup signals 215 (e.g., low-power wakeup signals). The UE 115-a may use the receiver 250-b to receive a PDCCH and other downlink data transmissions. As such, the receiver 250-b may be in a sleep mode (e.g., deactivated) until data is transmitted to the UE 115-a.

In some examples, the UE 115-a may receive control signaling 210 indicating a multi-wakeup signal configuration. The network node 105-a may configure the multi-wakeup signal configuration to indicate a wakeup signal window 220 during which the UE 115-a may monitor for one or more wakeup signals 215. In some examples, the wakeup signal window 220 may include a first wakeup signal occasion 225 and at least one second wakeup signal occasion 230. For example, the wakeup signal window 220 may include a second wakeup signal occasion 230-a, a second wakeup signal occasion 230-b, and a second wakeup signal occasion 230-c.

In some examples, the UE 115-a may be configured to receive mixed traffic from the network node 105-a during an upcoming ON duration of a DRX cycle 235 (e.g., an upcoming DRX on duration). The UE 115-a may be configured by the network entity with the DRX cycle 235 and a periodicity of the DRX cycle 235 (e.g., time duration over which the DRX cycle 235). The DRX cycle 235 may alternate between an ON duration (e.g., a first time period) and an OFF duration (e.g., second time period) during each time period, and the UE 115-a may cycle between the ON and OFF durations over time in accordance with a period of the DRX cycle. The UE can receive and transmit during each ON duration, and may enter a low power state during the OFF duration.

The network node 105-a may transmit different cases of mixed traffic, which may include a combination of XR video frame data and other traffic which the UE 115-a is to receive during the on duration of the DRX cycle 235. For example, in a first case (e.g., case 1), the network node 105-a may transmit only XR video frame data that may be associated with random arrival times and therefore, may be subject to jitter. In a second case (e.g., case 2), the network node 105-a may transmit only other data such as file transfers that are not subject to jitter. In a third case (e.g., case 3), the network node 105-a may transmit XR video frame data followed by some other data. In a fourth case (e.g., case 4), the network node 105-a may transmit some other data followed by the XR video frame data. In a fifth case (e.g., case 5), the network node 105-a may refrain from transmitting any data for the UE 115-a to receive during the on duration of the DRX cycle 235, such that the UE 115-a may skip the on duration.

Based on the various data the network node 105-a may transmit during a next on duration of the DRX cycle 235, the multi-wakeup signal configuration may indicate the first wakeup signal occasion 225 within the wakeup signal window 220, where the first wakeup signal occasion 225 may indicate whether the UE 115-a is to monitor an on duration of a DRX cycle 235. Additionally, the multi-wakeup signal configuration may indicate that the UE 115-a is to monitor at least one second wakeup signal occasion 230 within the wakeup signal window 220 when the UE 115-a detects a wakeup signal 215-a in the first wakeup signal occasion 225.

In some cases, the network node 105-a may transmit a wakeup signal 215-a in the first wakeup signal occasion 225 to indicate whether the UE 115-a may skip the on duration of the DRX cycle 235. That is, based on the multi-wakeup signal configuration, the UE 115-a may monitor for the wakeup signal 215-a in the first wakeup signal occasion 225. Based on whether the UE 115-a detects the wakeup signal 215-a in the first wakeup signal occasion 225, the UE 115-a may either skip the on duration of the DRX cycle 235 or continue monitoring for a wakeup signal 215-b in some quantity of second wakeup signal occasions 230 within the wakeup signal window 220.

If the UE 115-a fails to detect the wakeup signal 215-a in the first wakeup signal occasion 225 (e.g., based on the UE 115-a determining that the wakeup signal 215-a was not detected in the first wakeup signal occasion 225), the UE 115-a may skip the on duration of the DRX cycle 235. Alternatively, if the UE 115-a detects the wakeup signal 215-a in the first wakeup signal occasion 225, the UE 115-a may continue to monitor for the wakeup signal 215-b in one or more second wakeup signal occasions 230. In some examples, the first wakeup signal occasion 225 and the second wakeup signal occasion 230-a (e.g., the first of the second wakeup signal occasions 230) may at least partially overlap in time, in frequency, or both.

If there is data scheduled for the UE 115-a to receive in the on duration of the DRX cycle 235, the network node 105-a may transmit the wakeup signal 215-b on one of the second wakeup signal occasions 230 (e.g., an nth second wakeup signal occasion 230, which may be the first or a later second wakeup signal occasion). That is, the UE 115-a may receive the wakeup signal 215-b in the second wakeup signal occasion 230-a (e.g., the at least one second wakeup signal occasion 230), where the wakeup signal 215-b indicates that some data is scheduled to be transmitted to the UE 115-a within the on duration of the DRX cycle 235. Additionally, or alternatively, the network node 105-a may transmit the wakeup signal 215-b on remaining second wakeup signal occasions 230 that occur after the nth second wakeup signal occasion 230. For example, the network node 105-a may transmit the wakeup signal 215-b on the second wakeup signal occasion 230-b.

In some cases, a second wakeup signal occasion 230 may indicate a start time 240 of the on duration of the DRX cycle 235. That is, the UE 115-a may determine the start time 240 of the on duration of the DRX cycle 235 based on detecting the wakeup signal 215-b in the second wakeup signal occasion 230-a. In some cases, the UE 115-a may stop detecting wakeup signals 215 in any second wakeup signal occasions 230 after the second wakeup signal occasion 230 in which the UE 115-a detects the wakeup signal 215-b (e.g., the second wakeup signal occasion 230-a). The UE 115-a may skip the monitoring for the wakeup signal 215-b in one or more remaining second wakeup signal occasions 230 in the wakeup signal window 220 based on detecting the wakeup signal 215-b in the second wakeup signal occasion 230-a.

If the UE 115-a fails to detect the wakeup signal 215-b in any second wakeup signal occasion 230 within the wakeup signal window 220, the UE 115-a may skip the on duration of the DRX cycle 235. For example, if the UE 115-a has detected no wakeup signals 215 at the end of the wakeup signal window 220 (e.g., after monitoring each second wakeup signal occasion 230 within the wakeup signal window 220), the UE 115-a may enter a sleep mode until a next wakeup signal window occurs. If instead the UE 115-a detects the wakeup signal 215-b in the wakeup signal occasion 230-a (e.g., during a second wakeup signal occasion 230 within the wakeup signal window 220), the UE 115-a may transmit and receive communications during the on duration of the DRX cycle 235 and enter a low power mode until the next wakeup signal window occurs. In this way, the UE 115-a may enter and exit the on duration of the DRX cycle 235 in a cyclic manner. Accordingly, the UE 115-a may reduce power consumption while improving latency in wakeup signal detection by continuing to monitor wakeup signal occasions depending on what type of data the network node 105-a has scheduled to transmit during the on duration of the DRX cycle 235.

When jitter is present in XR traffic, it may be more power efficient for the UE 115-a to use little power for wakeup signal detection. As such, the UE 115-a may use the receiver 250-a (e.g., a separate, low-power wakeup receiver) for detecting wakeup signals 215 in a low-power mode (e.g., low-power wakeup signals). The UE 115-a may detect a wakeup signal 215 to identify whether data may be scheduled for transmission by the network node 105-a during the on duration of the DRX cycle 235. If there is data scheduled for the UE 115-a to receive, the UE 115-a may then use wakeup signal detection to identify whether jitter is present for XR video traffic with a given latency requirement and thus if the UE 115-a is to monitor multiple wakeup signal occasions for wakeup signals 215. In addition, if the data is scheduled, the UE 115-a may use the receiver 250-b to receive the data.

If the network node 105-a is to transmit only XR video frame data (e.g., case 1) or XR video frame data followed by some other data (e.g., traffic other than XE video frame data) during the on duration of the DRX cycle 235 (e.g., case 3), the UE 115-a may monitor up to all of the wakeup signal occasions within the wakeup signal window 220 up until the wakeup signal 215-b is detected. The wakeup signal 215-b may explicitly or implicitly indicate the start time 240 of the on duration of the DRX cycle 235, which may be an instant at which the UE 115-a may begin receiving DCI scheduling information and data (e.g., XR video frame data, other data, or both). Additionally, the UE 115-a may perform wakeup signal detection in multiple wakeup signal occasions as the network node 105-a may be unaware of a jitter value in advance (e.g., neither the network node 105-a nor the UE 115-a may know when jitter may occur). By using low-power wakeup signal detection, the UE 115-a may monitor for wakeup signals 215 in multiple wakeup signal occasions while maintaining a relatively low power consumption.

Alternatively, if the network node 105-a is to transmit only the other data (e.g., case 2), the other data followed by some XR video frame data (e.g., case 4), or no data (e.g., case 5) during the on duration of the DRX cycle 235, the UE 115-a may detect the wakeup signal 215-a (e.g., may detect a wakeup signal 215 once) despite there being multiple wakeup signal occasions (e.g., including the first wakeup signal occasion 225 and the second wakeup signal occasions 230) configured in the wakeup signal window 220. Detecting the wakeup signal 215-a may indicate that the UE 115-a is to skip the on duration of the DRX cycle 235 and save power if no data is scheduled to be transmitted. In this way, the UE 115-a may save power as the network node 105-a may transmit the same wakeup signal content (e.g., including the absence of a wakeup signal 215) on each wakeup signal occasion within the wakeup signal window 220.

As described herein, the wakeup signal 215-a that the UE 115-a detects in the first wakeup signal occasion 225 may indicate whether data is scheduled for transmission by the network node 105-a (e.g., reception by the UE 115-a) in the on duration of the DRX cycle 235. If the wakeup signal 215-a indicates that no data is scheduled for reception by the UE 115-a, the UE 115-a may immediately enter a sleep or other low power mode, which may result in greater power savings than the UE 115-a skipping the on duration of the DRX cycle 235 after attempting wakeup signal detection on each second wakeup signal occasion 230 and failing to detect the wakeup signal 215-b.

Additionally, the wakeup signal 215-b the UE 115-a detects in a second wakeup signal occasion 230 may indicate the start time 240 of the on duration of the DRX cycle 235, where the start time 240 may be an arrival time of data (e.g., XR video frame data) in the presence of jitter. If the wakeup signal 215-a indicated that no data was scheduled for transmission during the on duration of the DRX cycle 235, the network node 105-a may refrain from transmitting any wakeup signal 215 on any of the second wakeup signal occasions 230. In some examples, if other, non-video frame data (e.g., data excluding XR video frame data) is scheduled for transmission by the network node 105-a during the on duration of the DRX cycle 235, the network node 105-a may indicate that the UE 115-a is to skip the on duration of the DRX cycle 235 within the first wakeup signal occasion 225 (e.g., the network node 105-a may refrain from transmitting the wakeup signal 215-a). In this way, the network node 105-a may postpone transmission of the other data to a subsequent DRX cycle. Alternatively, if XR video frame data is being periodically generated, for example, by an application server for transmission by the network node 105-a (e.g., if the network node 105-a knows when XR video frame data is scheduled for transmission to the UE 115-a despite the application server having not yet transmitted the XR video frame data to the network node 105-a), the network node 105-a may transmit the wakeup signal 215-b for detection in a second wakeup signal occasion 230.

The wakeup signal 215-a transmitted in the first wakeup signal occasion 225 and the wakeup signal 215-b transmitted in the second wakeup signal occasion 230-a may be low-power wakeup signals. That is, the power the UE 115-a may consume to detect the wakeup signals 215 may be lower than for detecting other downlink transmissions (e.g., PDCCHs).

In some examples, after the UE 115-a detects the wakeup signal 215-b in the second wakeup signal occasion 230-a, the start time 240 of the on duration of the DRX cycle 235 may be determined. In some examples, the wakeup signal 215-b may explicitly indicate a time offset 245 from the second wakeup signal occasion 230-a (e.g., in which the UE 115-a detected the wakeup signal 215-b) to the start time 240 of the on duration of the DRX cycle 235. For example, the wakeup signal 215-b may be based on one of two candidate sequences each indicating a different offset. The UE 115-a may monitor the on duration of the DRX cycle 235 based on the start time 240 of the on duration of the DRX cycle 235 that is indicated in the wakeup signal 215-b. Alternatively, the start time 240 of the on duration of the DRX cycle 235 may be based on a predetermined offset from the second wakeup signal occasion 230-a in which the UE 115-a detected the wakeup signal 215-b to the start time 240 of the on duration of the DRX cycle 235. That is, the UE 115-a may monitor the on duration of the DRX cycle 235 at a start time 240 corresponding to the time offset 245 with respect to the second wakeup signal occasion in which the UE 115-a detected the wakeup signal 215-b.

The wakeup signal 215-a and the wakeup signal 215-b may have the same or different properties. For example, one or more sequences may be associated with the wakeup signal 215-a, the wakeup signal 215-b, or both (e.g., low-power wakeup signals may have sequence-based designs). That is, even if the network node 105-a transmits both of the wakeup signals 215 simultaneously, the UE 115-a may differentiate a sequence of the wakeup signal 215-a from a sequence of the wakeup signal 215-b based on the signaling the network node 105-a uses to transmit each of the wakeup signals 215. In some examples, one or more signaling types may be associated with the wakeup signal 215-a, the wakeup signal 215-b, or both. For example, the signaling of the wakeup signal 215-a transmitted in the first wakeup signal occasion 225 may be based on a sequence, while the signaling of the wakeup signal 215-b transmitted in the second wakeup signal occasion 230-a may be a PDCCH.

In some cases, one or more resource allocations may be associated with the wakeup signal 215-a, the wakeup signal 215-b, or both. For example, the network node 105-a may transmit the wakeup signals 215 using different bandwidths, frequency bands, resource blocks, and symbol quantities, among other resource allocations. Additionally, or alternatively, one or more modulations (e.g., modulation schemes) may be associated with the wakeup signal 215-a, the wakeup signal 215-b, or both. For example, the network node 105-a may transmit the wakeup signal 215-a in the first wakeup signal occasion 225 using a sequence with time domain modulation and the wakeup signal 215-b in the second wakeup signal occasion 230-a using a sequence with frequency domain modulation and a fast Fourier transform (FFT).

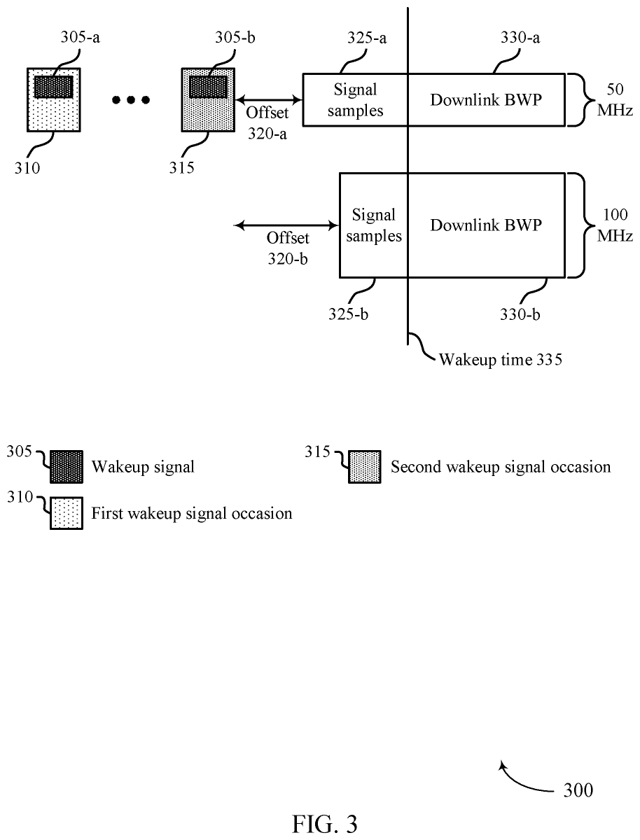

FIG. 3 illustrates an example of a transmission scheme 300 that supports adaptive jitter indication via a wakeup signal in accordance with one or more aspects of the present disclosure. In some examples, the transmission scheme 300 may implement aspects of the wireless communications systems 100 and 200 or may be implemented by aspects of the wireless communications systems 100 and 200. For example, a UE may receive one or more wakeup signals 305 from a network node in accordance with the transmission scheme 300, which may include the transmission of a downlink channel based on one or more time offsets.

In some examples, a UE may include multiple receivers dedicated to receiving different types of downlink transmissions from a network node to increase power savings for the UE. For example, the UE may support a first receiver, which may be a low-power, wakeup receiver, and a second receiver, which consumes relatively more power than the first receiver, by which the UE may receive a downlink channel. The first receiver may be an example of the receiver 250-a and the second receiver may be an example of the receiver 250-b as described with reference to FIG. 1. In some examples, the UE may use the first receiver to receive one or more wakeup signals 305 (e.g., low-power wakeup signals) from the network node, and to initiate a wakeup procedure to wake up the second receiver when the first receiver detects the one or more wakeup signals (e.g., cause the second receiver to transition from a sleep state to an ON state). For example, the UE may use the first receiver to receive a first wakeup signal in a first wakeup signal occasion. To reduce a wakeup delay of the UE (e.g., a time it takes the UE to activate the second receiver), the UE may begin capturing and buffering signal samples 325 of a downlink BWP 330 before the second receiver is fully activated (e.g., fully wakes up).

As the UE may buffer a limited quantity of signal samples 325, there may be a time offset (e.g., a minimum time offset) between a wakeup signal occasion in which the UE detects a wakeup signal and a time (e.g., a start time of the on duration of the DRX cycle) when the UE begins capturing the signal samples 325. In some examples, the UE may detect the wakeup signal in a first wakeup signal occasion (e.g., only having monitored one wakeup signal occasion), or in a later wakeup signal occasion. The shorter the time offset, the earlier the network node may begin transmitting downlink data to the UE, thus decreasing latency and increasing efficiency of the communications. Additionally, the faster the UE is able to activate or wake up the second receiver to receive the signal samples 325, the fewer the signal samples 325 the UE may have to store (e.g., buffer), and thus, the fewer the signal samples 325 the UE may process. In some cases, the time offset may depend on a bandwidth of an active bandwidth of the UE. The narrower the bandwidth is, the shorter the time offset may be given a fixed memory the UE may have for buffering the signal samples 325.

The UE may receive one or more wakeup signals 305 and a downlink channel from a network node based on the transmission scheme 300. In some cases, the UE may transmit a control message to the network node indicating a time offset (e.g., a first time offset) between a wakeup signal occasion and a downlink channel. The control message may include capability signaling or UE assistance information (UAI). The UE may use the first receiver to receive a wakeup signal 305-a in a first wakeup signal occasion 310, and the UE may use the first receiver to receive a wakeup signal 305-b in a second wakeup signal occasion 315, where the first wakeup signal occasion 310 and the second wakeup signal occasion 315 may be within a wakeup signal window. The wakeup signal 305-b may indicate to activate the second receiver of the UE and begin receiving the signal samples 325-a of a downlink BWP 330-a. That is, the UE may begin a process of activating or waking up the second receiver based on receiving the wakeup signal 305-b.

In some examples, there may be a time offset 320-a between the second wakeup signal occasion 315 (in which the UE detects the wakeup signal 305-b indicating for the UE to begin receiving a downlink channel having a downlink BWP 330-a) and a time instant (e.g., a beginning of a slot) when the UE begins to receive the downlink channel. For example, the UE may store the signal samples 325-a of the downlink BWP 330-a that are to be processed by the second receiver, where a first portion of the downlink channel occurs between a first time that is offset in time relative to the second wakeup signal occasion 315 and a wakeup time 335 of the second receiver. The UE may store the signal samples 325-a at a separate receiver (e.g., a third receiver) of the UE. After the wakeup time 335, the UE may receive the remainder of the downlink channel by the second receiver. In this way, the shorter the time offset 320, the faster the UE may receive the downlink channel fully and respond to data scheduling (e.g., scheduling DCI), thus lowering the latency of communications with the network node.

In some examples, the control message may indicate a single time offset associated with a reference bandwidth. The network node and the UE may determine the time offset 320-a (e.g., quantized in slot units) based on the single time offset (e.g., a reported time offset), the reference bandwidth, and an active BWP of the UE. For example, the UE may determine the time offset 320-a using an equation reported time offset/reference bandwidth x active BWP. Put another way, the UE may transmit the control message indicating the time offset 320-a that is a reference time offset associated with a reference bandwidth. The first portion of the downlink channel may occur between the first time that is offset in time by a second time offset relative to the second wakeup signal occasion 315 and the wakeup time 335 of the second receiver, where the second time offset is based on an active bandwidth of the downlink channel (e.g., the downlink BWP 330-a), the reference time offset, and the reference bandwidth.

Alternatively, the control message may indicate multiple time offsets 320 associated with multiple reference bandwidths of multiple downlink channels (e.g., downlink BWPs 330). The network node and the UE may use a time offset 320 corresponding to a smallest reference bandwidth that is larger than a bandwidth of the active BWP. For example, the UE may transmit the control message indicating a set of time offsets associated with respective reference bandwidths. The set of time offsets may include the time offset 320-a that is associated with a reference bandwidth of 50 MHz corresponding to the downlink BWP 330-a, and a time offset 320-b that is associated with a reference bandwidth of 100 MHz corresponding to a downlink BWP 330-b. The first portion of the downlink channel may occur between the first time that is offset in time by the time offset 320-b relative to the second wakeup signal occasion 315 and the wakeup time 335 of the second receiver. The time offset 320-b may correspond to a smallest reference bandwidth (e.g., 100 MHz) of the respective reference bandwidths that is larger than an active bandwidth of the downlink BWP 330-a (e.g., 50 MHz). Once the second receiver wakes up or is activated at the wakeup time 335, the UE may begin receiving signal samples 325-b of the downlink BWP 330-b based on the time offset 320-b.

Alternatively, the UE may report a time offset 320 for the active BWP in which the network entity has scheduled a transmission via downlink channel. That is, the UE may transmit the control message indicating the time offset 320 that corresponds to an active bandwidth of the downlink channel (e.g., a downlink BWP 330). For example, the control message may indicate the time offset 320-a corresponding to the 50 MHz bandwidth of the active downlink BWP 330-a or the time offset 320-b corresponding to the 100 MHz bandwidth of the active downlink BWP 330-b.

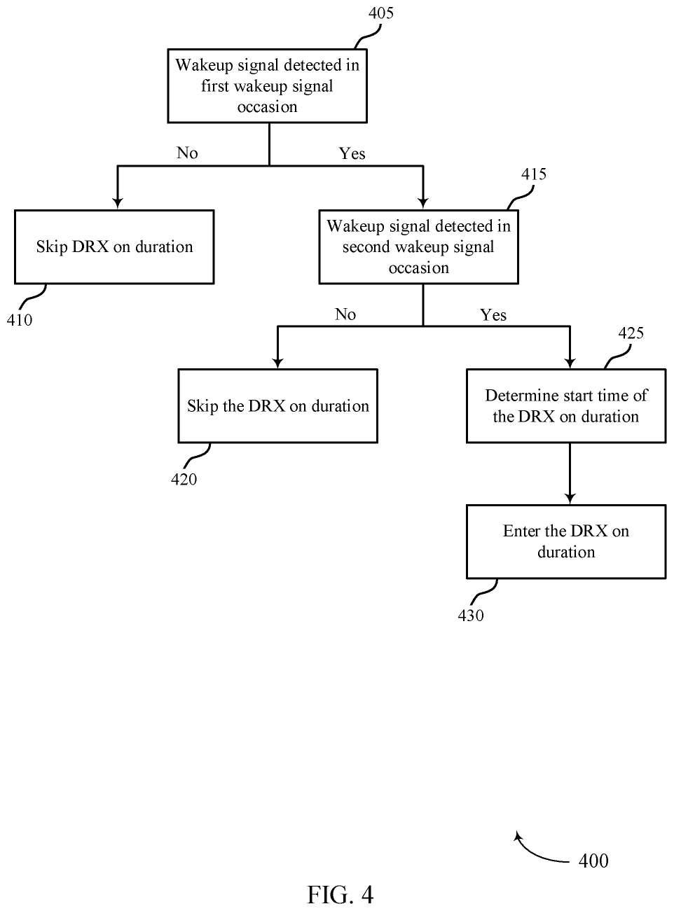

FIG. 4 illustrates an example of a process flow 400 that supports adaptive jitter indication via a wakeup signal in accordance with one or more aspects of the present disclosure. In some examples, the process flow 400 may implement aspects of the wireless communications systems 100 and 200, or may be implemented by aspects of the wireless communications systems 100 and 200. For example, a UE, which may be an example of a UE 115 as described herein, may use the process flow 400 to detect wakeup signals that may indicate whether data that may be subject to jitter is scheduled for transmission during an upcoming on duration of a DRX cycle. In the following description of the process flow 400, the operations performed by the UE may occur in a different order than the example order shown, or the operations performed by the UE may be performed in different orders or at different times. Some operations may also be omitted from the process flow 400, and other operations may be added to the process flow 400.

At 405, a network node may transmit a first wakeup signal to the UE in a first wakeup signal occasion. The first wakeup signal occasion may be within a wakeup signal window. In some examples, the UE may monitor for the first wakeup signal in the first wakeup signal occasion based on a multi-wakeup signal configuration configured by the network node.

At 410, the UE may determine that the first wakeup signal was not detected in the first wakeup signal occasion. Accordingly, the UE may skip an upcoming on duration of a DRX cycle. In some examples, the lack of the first wakeup signal in the first wakeup signal occasion may indicate to the UE that the network node has no data scheduled for transmission during the on duration of the DRX cycle, and as such, the UE may refrain from monitoring the on duration of the DRX cycle to save power.

At 415, the UE may detect the first wakeup signal in the first wakeup signal occasion. Based on detecting the first wakeup signal, the UE may monitor for a second wakeup signal transmitted by the network node in at least one second wakeup signal occasion. In some examples, the network node may transmit a second wakeup signal in the at least one second wakeup signal occasion if there is data scheduled to be transmitted during the on duration of the DRX cycle.

At 420, the UE may determine that the second wakeup signal was not detected in the at least one second wakeup signal occasion, and as such, the UE may skip the on duration of the DRX cycle. For example, the UE may fail to detect the second wakeup signal or the network node may refrain from transmitting the second wakeup signal if there is no data (e.g., XR video frame data) scheduled for transmission during the on duration of the DRX cycle.

At 425, the UE may detect the second wakeup signal in the at least one second wakeup signal occasion. Based on detecting the second wakeup signal, the UE may determine a start time of the on duration of the DRX cycle. In some examples, the second wakeup signal may explicitly indicate a start time of the on duration of the DRX cycle. Alternatively, the UE may determine the start time based on a time offset with respect to the at least one second wakeup signal occasion in which the UE detected the second wakeup signal.

At 430, based on determining the start time of the on duration of the DRX cycle, the UE may enter the on duration of the DRX cycle and receive data (e.g., XR video frame data) transmitted by the network node.

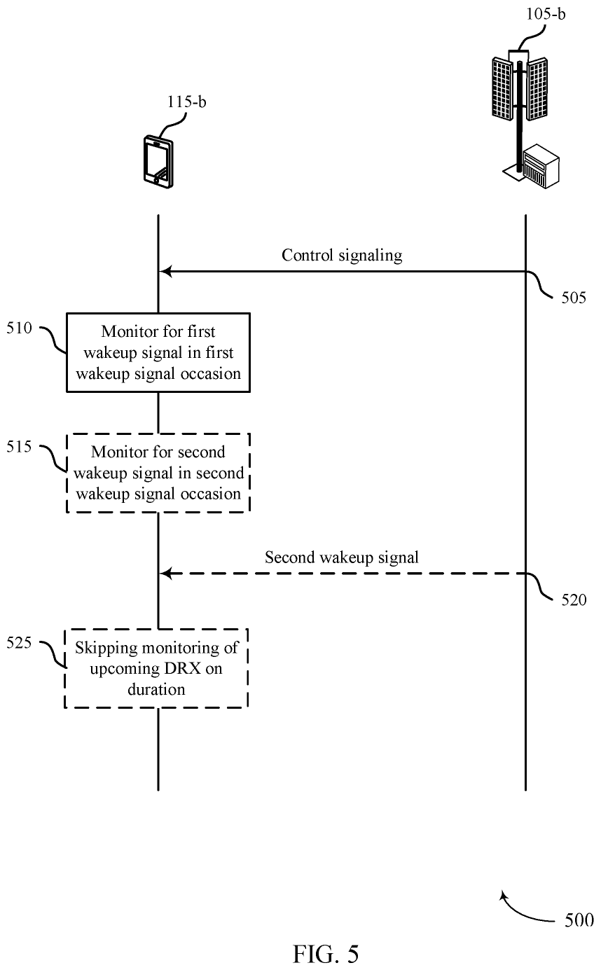

FIG. 5 illustrates an example of a process flow 500 that supports adaptive jitter indication via a wakeup signal in accordance with one or more aspects of the present disclosure. The process flow 500 may implement aspects of wireless communications systems 100 and 200, or may be implemented by aspects of the wireless communications system 100 and 200. For example, the process flow 500 may illustrate operations between a UE 115-b and a network node 105-b (e.g., a network entity), which may be examples of corresponding devices described herein. In the following description of the process flow 500, the operations between the UE 115-b and the network node 105-b may be transmitted in a different order than the example order shown, or the operations performed by the UE 115-b and the network node 105-b may be performed in different orders or at different times. Some operations may also be omitted from the process flow 500, and other operations may be added to the process flow 500.

At 505, the UE 115-b may receive, from the network node 105-b, control signaling indicating a multi-wakeup signal configuration, the multi-wakeup signal configuration indicating a wakeup signal window, indicating a first wakeup signal occasion within the wakeup signal window that indicates whether to monitor an upcoming on duration of a DRX, and indicating to monitor at least one second wakeup signal occasion within the wakeup signal window when a first wakeup signal is detected in the first wakeup signal occasion. In some examples, the at least one second wakeup signal occasion indicating a start time of the upcoming on duration of the DRX cycle. In some cases, the at least one second wakeup signal occasion may implicitly indicate the start time of the upcoming on duration relative to the at least one second wakeup signal occasion (e.g., the upcoming on duration has a start time that is offset in time by a defined amount from a second wakeup signal occasion, where the offset is configured by the network entity 105-b). In some cases, the at least one second wakeup signal occasion may indicate the start time of the upcoming on duration by transporting the second wakeup signal that explicitly indicates the start time of the upcoming on duration.

At 510, the UE 115-b may monitor for the first wakeup signal in the first wakeup signal occasion based on the multi-wakeup signal configuration. In some examples, the first wakeup signal may indicate whether the UE 115-b may skip the upcoming on duration of the DRX cycle, for example, based on whether data is scheduled for transmission during the upcoming on duration of the DRX cycle.

At 515 the UE 115-b may monitor for a second wakeup signal in the at least one second wakeup signal occasion based on monitoring for and detecting the first wakeup signal in the first wakeup signal occasion. For example, the network node 105-b may transmit the second wakeup signal based on there being data scheduled for the UE 115-b to receive in the upcoming on duration of the DRX cycle. In some examples, the UE 115-b may determine a start time of the upcoming on duration of the DRX cycle based on the second wakeup signal (e.g., based on the second wakeup signal occasion in which the UE 115-a detected the second wakeup signal).

At 520, the UE 115-b may receive the second wakeup signal in the at least one second wakeup signal occasion, the second wakeup signal indicating that data is scheduled to be transmitted to the UE 115-b within the upcoming on duration of the DRX cycle. That is, the network node 105-b may transmit the second wakeup signal if the UE 115-b is to monitor the on duration of the DRX cycle (e.g., even if the UE 115-b may wait until a start time before entering the on duration of the DRX cycle).

At 525, the UE 115-b may skip monitoring of the upcoming on duration of the DRX cycle based on monitoring for the first wakeup signal in the first wakeup signal occasion and determining that the first signal was not detected. For example, the UE 115-b may skip the monitoring to save power if there is no data scheduled for transmission to the UE 115-b during the on duration of the DRX cycle.

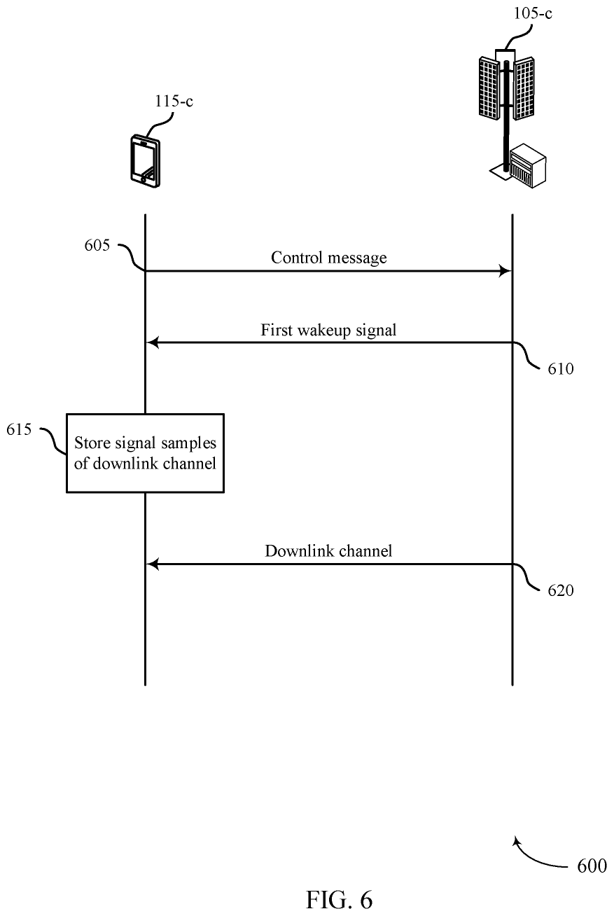

FIG. 6 illustrates an example of a process flow 600 that supports adaptive jitter indication via a wakeup signal in accordance with one or more aspects of the present disclosure. The process flow 600 may implement aspects of wireless communications systems 100 and 200, or may be implemented by aspects of the wireless communications system 100 and 200. For example, the process flow 600 may illustrate operations between a UE 115-c and a network node 105-c (e.g., a network entity), which may be examples of corresponding devices described herein. In the following description of the process flow 600, the operations between the UE 115-c and the network node 105-c may be transmitted in a different order than the example order shown, or the operations performed by the UE 115-c and the network node 105-c may be performed in different orders or at different times. Some operations may also be omitted from the process flow 600, and other operations may be added to the process flow 600.

At 605, the UE 115-c may transmit, to the network node 105-c, a control message indicating a first time offset between a wakeup signal occasion and a downlink channel. The control message may be a capability message (e.g., indicating a capability of the UE 115-c) or UAI.

At 610, the UE 115-c may receive, by a first receiver of the UE and from the network node 105-c, a first wakeup signal in a first wakeup signal occasion that indicates to activate a second receiver of the UE. In some examples, the first receiver may be a low-power wakeup receiver used for receiving low-power wakeup signals, and the second receiver may be used for receiving a downlink channel. In activating the second receiver, the UE may begin a buffer and receive signal samples of the downlink channel before receiving the entire downlink channel.

At 615, the UE 115-c may store the signal samples of the downlink channel that are to be processed by the second receiver, where a portion of the downlink channel occurs between a first time that is offset in time relative to the first wakeup signal occasion and a wakeup time of the second receiver. That is, there may be a time offset between the first wakeup signal occasion (in which the UE detects the first wakeup signal indicating the UE 115-c to receive the downlink channel) and a time instant (e.g., a beginning of a slot) when the UE 115-c may begin to receive the downlink channel.

At 620, the UE 115-c may receive, by the second receiver of the UE and after the wakeup time, the remainder of the downlink channel. That is, once the second receiver is fully activated or awake, the UE 115-c may pause the storage of the signal samples and use the second receiver to receive the downlink channel itself and respond to data scheduling (e.g., scheduling DCI).

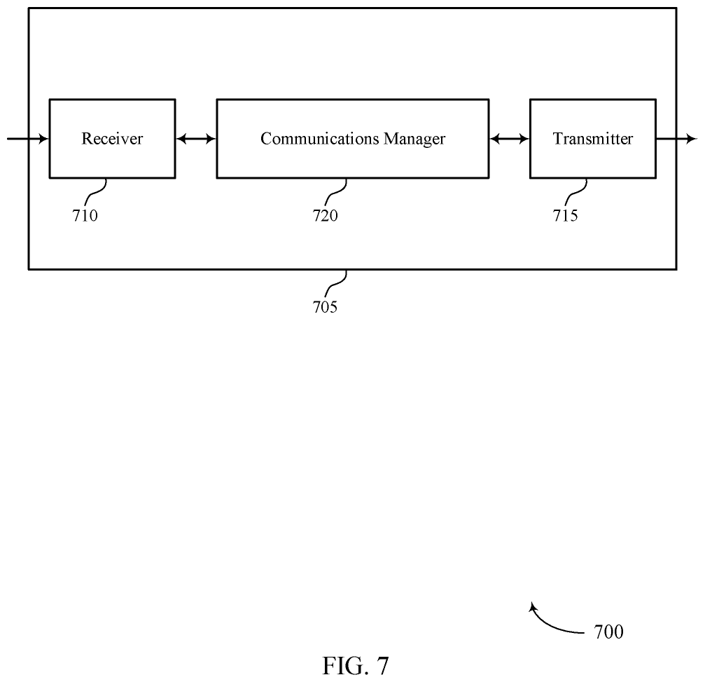

FIG. 7 shows a block diagram 700 of a device 705 that supports adaptive jitter indication via a wakeup signal in accordance with one or more aspects of the present disclosure. The device 705 may be an example of aspects of a UE 115 as described herein. The device 705 may include a receiver 710, a transmitter 715, and a communications manager 720. The device 705 may also include a processor. Each of these components may be in communication with one another (e.g., via one or more buses).

The receiver 710 may provide a means for receiving information such as packets, user data, control information, or any combination thereof associated with various information channels (e.g., control channels, data channels, information channels related to adaptive jitter indication via a wakeup signal). Information may be passed on to other components of the device 705. The receiver 710 may utilize a single antenna or a set of multiple antennas.

The transmitter 715 may provide a means for transmitting signals generated by other components of the device 705. For example, the transmitter 715 may transmit information such as packets, user data, control information, or any combination thereof associated with various information channels (e.g., control channels, data channels, information channels related to adaptive jitter indication via a wakeup signal). In some examples, the transmitter 715 may be co-located with a receiver 710 in a transceiver module. The transmitter 715 may utilize a single antenna or a set of multiple antennas.

The communications manager 720, the receiver 710, the transmitter 715, or various combinations thereof or various components thereof may be examples of means for performing various aspects of adaptive jitter indication via a wakeup signal as described herein. For example, the communications manager 720, the receiver 710, the transmitter 715, or various combinations or components thereof may support a method for performing one or more of the functions described herein.

In some examples, the communications manager 720, the receiver 710, the transmitter 715, or various combinations or components thereof may be implemented in hardware (e.g., in communications management circuitry). The hardware may include a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally, or alternatively, in some examples, the communications manager 720, the receiver 710, the transmitter 715, or various combinations or components thereof may be implemented in code (e.g., as communications management software or firmware) executed by a processor. If implemented in code executed by a processor, the functions of the communications manager 720, the receiver 710, the transmitter 715, or various combinations or components thereof may be performed by a general-purpose processor, a DSP, a CPU, an ASIC, an FPGA, a microcontroller, or any combination of these or other programmable logic devices (e.g., configured as or otherwise supporting a means for performing the functions described in the present disclosure).

In some examples, the communications manager 720 may be configured to perform various operations (e.g., receiving, obtaining, monitoring, outputting, transmitting) using or otherwise in cooperation with the receiver 710, the transmitter 715, or both. For example, the communications manager 720 may receive information from the receiver 710, send information to the transmitter 715, or be integrated in combination with the receiver 710, the transmitter 715, or both to obtain information, output information, or perform various other operations as described herein.

The communications manager 720 may support wireless communication at a UE in accordance with examples as disclosed herein. For example, the communications manager 720 may be configured as or otherwise support a means for receiving control signaling indicating a multi-wakeup signal configuration, the multi-wakeup signal configuration indicating a wakeup signal window, indicating a first wakeup signal occasion within the wakeup signal window that indicates whether to monitor an upcoming on duration of a DRX cycle, and indicating to monitor at least one second wakeup signal occasion within the wakeup signal window when a first wakeup signal is detected in the first wakeup signal occasion, the at least one second wakeup signal occasion indicating a start time of the upcoming on duration of the DRX cycle. The communications manager 720 may be configured as or otherwise support a means for monitoring for the first wakeup signal in the first wakeup signal occasion based on the multi-wakeup signal configuration. The communications manager 720 may be configured as or otherwise support a means for monitoring for a second wakeup signal in the at least one second wakeup signal occasion, or skipping monitoring of the upcoming on duration of the DRX cycle, based on monitoring for the first wakeup signal in the first wakeup signal occasion.

Additionally, or alternatively, the communications manager 720 may support wireless communication at a UE in accordance with examples as disclosed herein. For example, the communications manager 720 may be configured as or otherwise support a means for transmitting a control message indicating a first time offset between a wakeup signal occasion and a downlink channel. The communications manager 720 may be configured as or otherwise support a means for receiving, by a first receiver of the UE, a first wakeup signal in a first wakeup signal occasion that indicates to activate a second receiver of the UE. The communications manager 720 may be configured as or otherwise support a means for storing signal samples of the downlink channel that are to be processed by the second receiver, where a first portion of the downlink channel occurs between a first time that is offset in time relative to the first wakeup signal occasion and a wakeup time of the second receiver. The communications manager 720 may be configured as or otherwise support a means for receiving, by the second receiver and after the wakeup time, a remainder of the downlink channel.

By including or configuring the communications manager 720 in accordance with examples as described herein, the device 705 (e.g., a processor controlling or otherwise coupled with the receiver 710, the transmitter 715, the communications manager 720, or a combination thereof) may support techniques for adaptive jitter indication via wakeup signals, which may reduce latency and reduce power consumption based on the device 705 refraining from monitoring DRX on duration if no data is scheduled for reception during the DRX on duration.

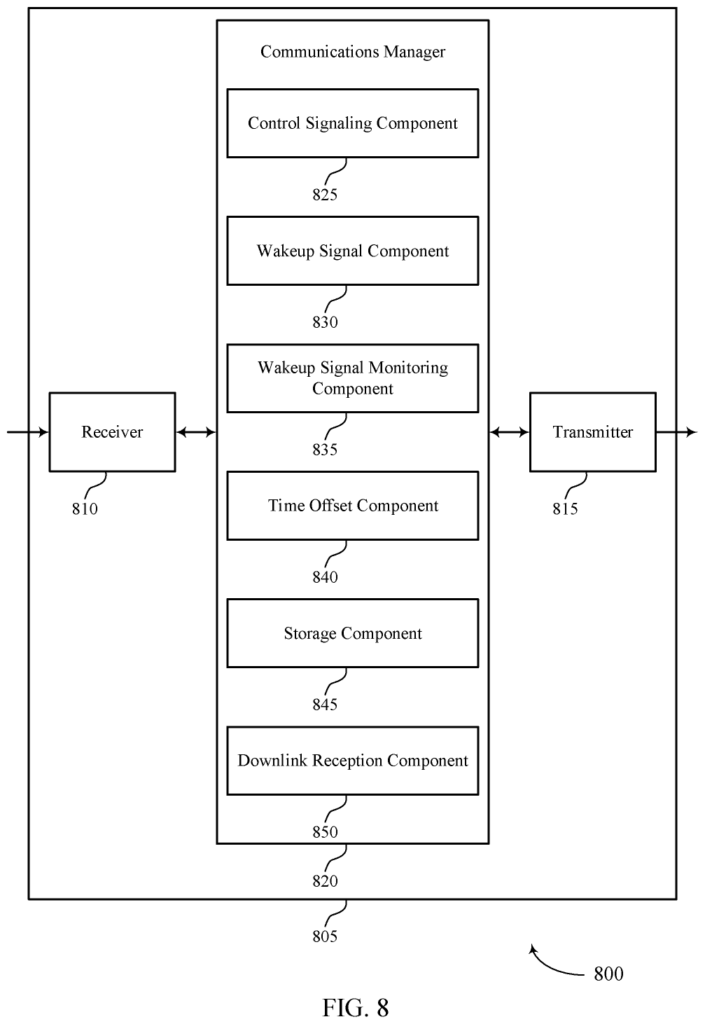

FIG. 8 shows a block diagram 800 of a device 805 that supports adaptive jitter indication via a wakeup signal in accordance with one or more aspects of the present disclosure. The device 805 may be an example of aspects of a device 705 or a UE 115 as described herein. The device 805 may include a receiver 810, a transmitter 815, and a communications manager 820. The device 805 may also include a processor. Each of these components may be in communication with one another (e.g., via one or more buses).

The receiver 810 may provide a means for receiving information such as packets, user data, control information, or any combination thereof associated with various information channels (e.g., control channels, data channels, information channels related to adaptive jitter indication via a wakeup signal). Information may be passed on to other components of the device 805. The receiver 810 may utilize a single antenna or a set of multiple antennas.

The transmitter 815 may provide a means for transmitting signals generated by other components of the device 805. For example, the transmitter 815 may transmit information such as packets, user data, control information, or any combination thereof associated with various information channels (e.g., control channels, data channels, information channels related to adaptive jitter indication via a wakeup signal). In some examples, the transmitter 815 may be co-located with a receiver 810 in a transceiver module. The transmitter 815 may utilize a single antenna or a set of multiple antennas.

The device 805, or various components thereof, may be an example of means for performing various aspects of adaptive jitter indication via a wakeup signal as described herein. For example, the communications manager 820 may include a control signaling component 825, a wakeup signal component 830, a wakeup signal monitoring component 835, a time offset component 840, a storage component 845, a downlink reception component 850, or any combination thereof. The communications manager 820 may be an example of aspects of a communications manager 720 as described herein. In some examples, the communications manager 820, or various components thereof, may be configured to perform various operations (e.g., receiving, obtaining, monitoring, outputting, transmitting) using or otherwise in cooperation with the receiver 810, the transmitter 815, or both. For example, the communications manager 820 may receive information from the receiver 810, send information to the transmitter 815, or be integrated in combination with the receiver 810, the transmitter 815, or both to obtain information, output information, or perform various other operations as described herein.

The communications manager 820 may support wireless communication at a UE in accordance with examples as disclosed herein. The control signaling component 825 may be configured as or otherwise support a means for receiving control signaling indicating a multi-wakeup signal configuration, the multi-wakeup signal configuration indicating a wakeup signal window, indicating a first wakeup signal occasion within the wakeup signal window that indicates whether to monitor an upcoming on duration of a DRX cycle, and indicating to monitor at least one second wakeup signal occasion within the wakeup signal window when a first wakeup signal is detected in the first wakeup signal occasion, the at least one second wakeup signal occasion indicating a start time of the upcoming on duration of the DRX cycle. The wakeup signal component 830 may be configured as or otherwise support a means for monitoring for the first wakeup signal in the first wakeup signal occasion based on the multi-wakeup signal configuration. The wakeup signal monitoring component 835 may be configured as or otherwise support a means for monitoring for a second wakeup signal in the at least one second wakeup signal occasion, or skipping monitoring of the upcoming on duration of the DRX cycle, based on monitoring for the first wakeup signal in the first wakeup signal occasion.

Additionally, or alternatively, the communications manager 820 may support wireless communication at a UE in accordance with examples as disclosed herein. The time offset component 840 may be configured as or otherwise support a means for transmitting a control message indicating a first time offset between a wakeup signal occasion and a downlink channel. The wakeup signal component 830 may be configured as or otherwise support a means for receiving, by a first receiver of the UE, a first wakeup signal in a first wakeup signal occasion that indicates to activate a second receiver of the UE. The storage component 845 may be configured as or otherwise support a means for storing signal samples of the downlink channel that are to be processed by the second receiver, where a first portion of the downlink channel occurs between a first time that is offset in time relative to the first wakeup signal occasion and a wakeup time of the second receiver. The downlink reception component 850 may be configured as or otherwise support a means for receiving, by the second receiver and after the wakeup time, a remainder of the downlink channel.

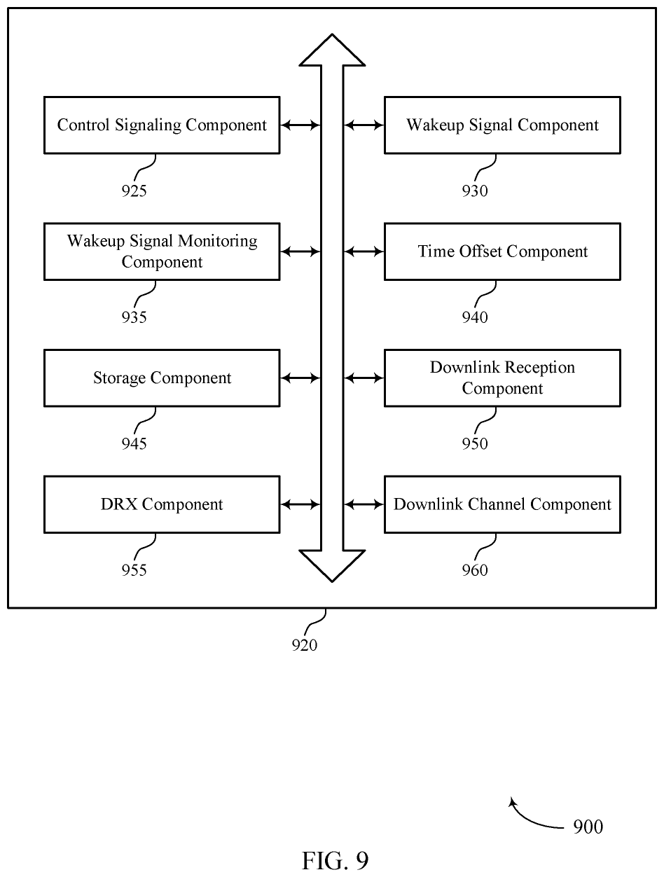

FIG. 9 shows a block diagram 900 of a communications manager 920 that supports adaptive jitter indication via a wakeup signal in accordance with one or more aspects of the present disclosure. The communications manager 920 may be an example of aspects of a communications manager 720, a communications manager 820, or both, as described herein. The communications manager 920, or various components thereof, may be an example of means for performing various aspects of adaptive jitter indication via a wakeup signal as described herein. For example, the communications manager 920 may include a control signaling component 925, a wakeup signal component 930, a wakeup signal monitoring component 935, a time offset component 940, a storage component 945, a downlink reception component 950, a DRX component 955, a downlink channel component 960, or any combination thereof. Each of these components may communicate, directly or indirectly, with one another (e.g., via one or more buses).

The communications manager 920 may support wireless communication at a UE in accordance with examples as disclosed herein. The control signaling component 925 may be configured as or otherwise support a means for receiving control signaling indicating a multi-wakeup signal configuration, the multi-wakeup signal configuration indicating a wakeup signal window, indicating a first wakeup signal occasion within the wakeup signal window that indicates whether to monitor an upcoming on duration of a DRX cycle, and indicating to monitor at least one second wakeup signal occasion within the wakeup signal window when a first wakeup signal is detected in the first wakeup signal occasion, the at least one second wakeup signal occasion indicating a start time of the upcoming on duration of the DRX cycle. The wakeup signal component 930 may be configured as or otherwise support a means for monitoring for the first wakeup signal in the first wakeup signal occasion based on the multi-wakeup signal configuration. The wakeup signal monitoring component 935 may be configured as or otherwise support a means for monitoring for a second wakeup signal in the at least one second wakeup signal occasion, or skipping monitoring of the upcoming on duration of the DRX cycle, based on monitoring for the first wakeup signal in the first wakeup signal occasion.

In some examples, the DRX component 955 may be configured as or otherwise support a means for skipping the monitoring of the upcoming on duration of the DRX cycle based on determining that the first wakeup signal was not detected in the first wakeup signal occasion.

In some examples, the wakeup signal monitoring component 935 may be configured as or otherwise support a means for monitoring for the second wakeup signal in the at least one second wakeup signal occasion based on detecting the first wakeup signal in the first wakeup signal occasion.

In some examples, the wakeup signal monitoring component 935 may be configured as or otherwise support a means for receiving the second wakeup signal in the at least one second wakeup signal occasion, the second wakeup signal indicating that data is scheduled to be transmitted to the UE within the upcoming on duration of the DRX cycle.

In some examples, the wakeup signal monitoring component 935 may be configured as or otherwise support a means for skipping the monitoring for the second wakeup signal in one or more remaining second wakeup signal occasions in the wakeup signal window based on detecting the second wakeup signal in the at least one second wakeup signal occasion.

In some examples, the DRX component 955 may be configured as or otherwise support a means for monitoring the upcoming on duration of the DRX cycle based on the start time of the upcoming on duration of the DRX cycle indicated in the second wakeup signal.

In some examples, the DRX component 955 may be configured as or otherwise support a means for monitoring the upcoming on duration of the DRX cycle at the start time of the upcoming on duration of the DRX cycle corresponding to a time offset with respect to the at least one second wakeup signal occasion in which the UE detects the second wakeup signal.

In some examples, the first wakeup signal occasion and the at least one second wakeup signal occasion at least partially overlap in time, in frequency, or both. In some examples, one or more sequences are associated with the first wakeup signal, the second wakeup signal, or both. In some examples, one or more signaling types are associated with the first wakeup signal, the second wakeup signal, or both. In some examples, one or more resource allocations are associated with the first wakeup signal, the second wakeup signal, or both. In some examples, one or more modulations are associated with the first wakeup signal, the second wakeup signal, or both.

Additionally, or alternatively, the communications manager 920 may support wireless communication at a UE in accordance with examples as disclosed herein. The time offset component 940 may be configured as or otherwise support a means for transmitting a control message indicating a first time offset between a wakeup signal occasion and a downlink channel. In some examples, the wakeup signal component 930 may be configured as or otherwise support a means for receiving, by a first receiver of the UE, a first wakeup signal in a first wakeup signal occasion that indicates to activate a second receiver of the UE. The storage component 945 may be configured as or otherwise support a means for storing signal samples of the downlink channel that are to be processed by the second receiver, where a first portion of the downlink channel occurs between a first time that is offset in time relative to the first wakeup signal occasion and a wakeup time of the second receiver. The downlink reception component 950 may be configured as or otherwise support a means for receiving, by the second receiver and after the wakeup time, a remainder of the downlink channel.

In some examples, to support transmitting the control message, the time offset component 940 may be configured as or otherwise support a means for transmitting the control message indicating the first time offset that is a reference time offset associated with a reference bandwidth, where the first portion of the downlink channel occurs between the first time that is offset in time by a second time offset relative to the first wakeup signal occasion and the wakeup time of the second receiver, the second time offset based on an active bandwidth of the downlink channel, the reference time offset, and the reference bandwidth.

In some examples, to support transmitting the control message, the downlink channel component 960 may be configured as or otherwise support a means for transmitting the control message indicating a set of multiple time offsets associated with respective reference bandwidths, the set of multiple time offsets including the first time offset, where the first portion of the downlink channel occurs between the first time that is offset in time by a second time offset relative to the first wakeup signal occasion and the wakeup time of the second receiver, where the second time offset corresponds to one of the set of multiple time offsets. In some examples, the second time offset corresponds to a smallest reference bandwidth of the respective reference bandwidths that is larger than an active bandwidth of the downlink channel.

In some examples, to support transmitting the control message, the time offset component 940 may be configured as or otherwise support a means for transmitting the control message indicating the time offset that corresponds to an active bandwidth of the downlink channel. In some examples, the control message includes UE capability signaling or UAI.

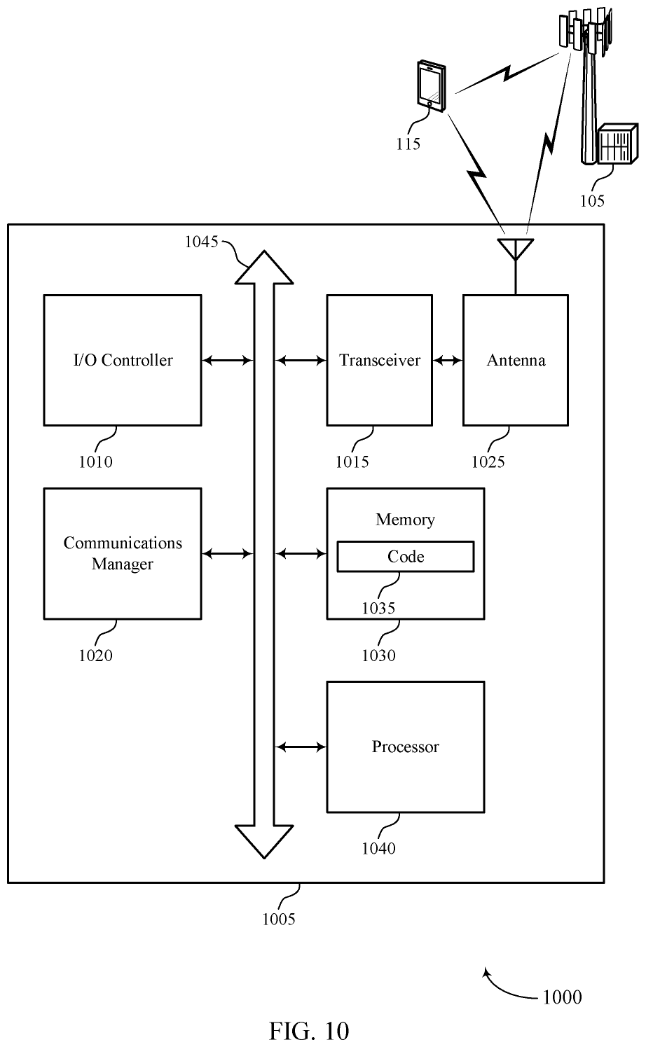

FIG. 10 shows a diagram of a system 1000 including a device 1005 that supports adaptive jitter indication via a wakeup signal in accordance with one or more aspects of the present disclosure. The device 1005 may be an example of or include the components of a device 705, a device 805, or a UE 115 as described herein. The device 1005 may communicate (e.g., wirelessly) with one or more network entities 105, one or more UEs 115, or any combination thereof. The device 1005 may include components for bi-directional voice and data communications including components for transmitting and receiving communications, such as a communications manager 1020, an input/output (I/O) controller 1010, a transceiver 1015, an antenna 1025, a memory 1030, code 1035, and a processor 1040. These components may be in electronic communication or otherwise coupled (e.g., operatively, communicatively, functionally, electronically, electrically) via one or more buses (e.g., a bus 1045).

The I/O controller 1010 may manage input and output signals for the device 1005. The I/O controller 1010 may also manage peripherals not integrated into the device 1005. In some cases, the I/O controller 1010 may represent a physical connection or port to an external peripheral. In some cases, the I/O controller 1010 may utilize an operating system such as iOS®, ANDROID®, MS-DOS®, MS-WINDOWS®, OS/2®, UNIX®, LINUX®, or another known operating system. Additionally, or alternatively, the I/O controller 1010 may represent or interact with a modem, a keyboard, a mouse, a touchscreen, or a similar device. In some cases, the I/O controller 1010 may be implemented as part of a processor, such as the processor 1040. In some cases, a user may interact with the device 1005 via the I/O controller 1010 or via hardware components controlled by the I/O controller 1010.

In some cases, the device 1005 may include a single antenna 1025. However, in some other cases, the device 1005 may have more than one antenna 1025, which may be capable of concurrently transmitting or receiving multiple wireless transmissions. The transceiver 1015 may communicate bi-directionally, via the one or more antennas 1025, wired, or wireless links as described herein. For example, the transceiver 1015 may represent a wireless transceiver and may communicate bi-directionally with another wireless transceiver. The transceiver 1015 may also include a modem to modulate the packets, to provide the modulated packets to one or more antennas 1025 for transmission, and to demodulate packets received from the one or more antennas 1025. The transceiver 1015, or the transceiver 1015 and one or more antennas 1025, may be an example of a transmitter 715, a transmitter 815, a receiver 710, a receiver 810, or any combination thereof or component thereof, as described herein.

The memory 1030 may include random access memory (RAM) and read-only memory (ROM). The memory 1030 may store computer-readable, computer-executable code 1035 including instructions that, when executed by the processor 1040, cause the device 1005 to perform various functions described herein. The code 1035 may be stored in a non-transitory computer-readable medium such as system memory or another type of memory. In some cases, the code 1035 may not be directly executable by the processor 1040 but may cause a computer (e.g., when compiled and executed) to perform functions described herein. In some cases, the memory 1030 may contain, among other things, a basic I/O system (BIOS) which may control basic hardware or software operation such as the interaction with peripheral components or devices.

The processor 1040 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 1040 may be configured to operate a memory array using a memory controller. In some other cases, a memory controller may be integrated into the processor 1040. The processor 1040 may be configured to execute computer-readable instructions stored in a memory (e.g., the memory 1030) to cause the device 1005 to perform various functions (e.g., functions or tasks supporting adaptive jitter indication via a wakeup signal). For example, the device 1005 or a component of the device 1005 may include a processor 1040 and memory 1030 coupled with or to the processor 1040, the processor 1040 and memory 1030 configured to perform various functions described herein.

The communications manager 1020 may support wireless communication at a UE in accordance with examples as disclosed herein. For example, the communications manager 1020 may be configured as or otherwise support a means for receiving control signaling indicating a multi-wakeup signal configuration, the multi-wakeup signal configuration indicating a wakeup signal window, indicating a first wakeup signal occasion within the wakeup signal window that indicates whether to monitor an upcoming on duration of a DRX cycle, and indicating to monitor at least one second wakeup signal occasion within the wakeup signal window when a first wakeup signal is detected in the first wakeup signal occasion, the at least one second wakeup signal occasion indicating a start time of the upcoming on duration of the DRX cycle. The communications manager 1020 may be configured as or otherwise support a means for monitoring for the first wakeup signal in the first wakeup signal occasion based on the multi-wakeup signal configuration. The communications manager 1020 may be configured as or otherwise support a means for monitoring for a second wakeup signal in the at least one second wakeup signal occasion, or skipping monitoring of the upcoming on duration of the DRX cycle, based on monitoring for the first wakeup signal in the first wakeup signal occasion.

Additionally, or alternatively, the communications manager 1020 may support wireless communication at a UE in accordance with examples as disclosed herein. For example, the communications manager 1020 may be configured as or otherwise support a means for transmitting a control message indicating a first time offset between a wakeup signal occasion and a downlink channel. The communications manager 1020 may be configured as or otherwise support a means for receiving, by a first receiver of the UE, a first wakeup signal in a first wakeup signal occasion that indicates to activate a second receiver of the UE. The communications manager 1020 may be configured as or otherwise support a means for storing signal samples of the downlink channel that are to be processed by the second receiver, where a first portion of the downlink channel occurs between a first time that is offset in time relative to the first wakeup signal occasion and a wakeup time of the second receiver. The communications manager 1020 may be configured as or otherwise support a means for receiving, by the second receiver and after the wakeup time, a remainder of the downlink channel.

By including or configuring the communications manager 1020 in accordance with examples as described herein, the device 1005 may support techniques for adaptive jitter indication via wakeup signals, which may reduce latency and reduce power consumption based on refraining from monitoring DRX on duration if no data is scheduled for reception during the DRX on duration.

In some examples, the communications manager 1020 may be configured to perform various operations (e.g., receiving, monitoring, transmitting) using or otherwise in cooperation with the transceiver 1015, the one or more antennas 1025, or any combination thereof. Although the communications manager 1020 is illustrated as a separate component, in some examples, one or more functions described with reference to the communications manager 1020 may be supported by or performed by the processor 1040, the memory 1030, the code 1035, or any combination thereof. For example, the code 1035 may include instructions executable by the processor 1040 to cause the device 1005 to perform various aspects of adaptive jitter indication via a wakeup signal as described herein, or the processor 1040 and the memory 1030 may be otherwise configured to perform or support such operations.

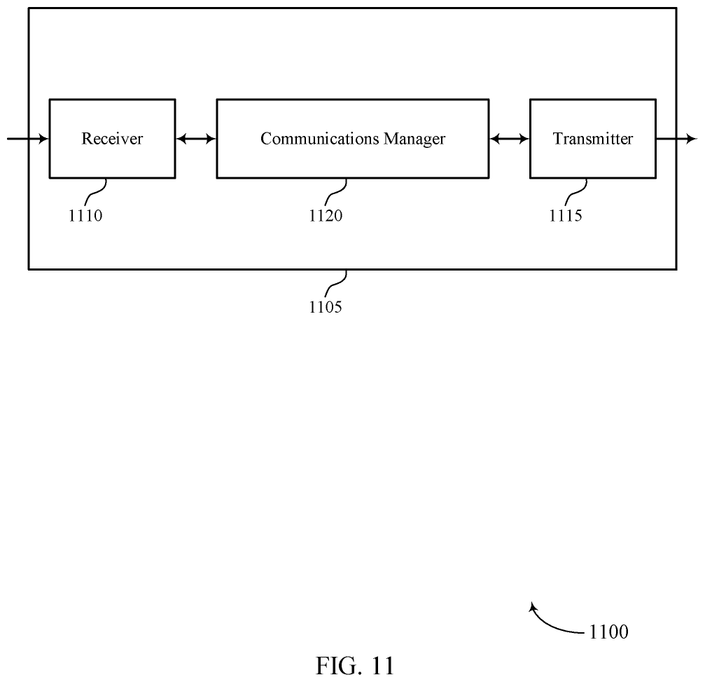

FIG. 11 shows a block diagram 1100 of a device 1105 that supports adaptive jitter indication via a wakeup signal in accordance with one or more aspects of the present disclosure. The device 1105 may be an example of aspects of a network node as described herein. The device 1105 may include a receiver 1110, a transmitter 1115, and a communications manager 1120. The device 1105 may also include a processor. Each of these components may be in communication with one another (e.g., via one or more buses).

The receiver 1110 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1105. In some examples, the receiver 1110 may support obtaining information by receiving signals via one or more antennas. Additionally, or alternatively, the receiver 1110 may support obtaining information by receiving signals via one or more wired (e.g., electrical, fiber optic) interfaces, wireless interfaces, or any combination thereof.

The transmitter 1115 may provide a means for outputting (e.g., transmitting, providing, conveying, sending) information generated by other components of the device 1105. For example, the transmitter 1115 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1115 may support outputting information by transmitting signals via one or more antennas. Additionally, or alternatively, the transmitter 1115 may support outputting information by transmitting signals via one or more wired (e.g., electrical, fiber optic) interfaces, wireless interfaces, or any combination thereof. In some examples, the transmitter 1115 and the receiver 1110 may be co-located in a transceiver, which may include or be coupled with a modem.

The communications manager 1120, the receiver 1110, the transmitter 1115, or various combinations thereof or various components thereof may be examples of means for performing various aspects of adaptive jitter indication via a wakeup signal as described herein. For example, the communications manager 1120, the receiver 1110, the transmitter 1115, or various combinations or components thereof may support a method for performing one or more of the functions described herein.

In some examples, the communications manager 1120, the receiver 1110, the transmitter 1115, or various combinations or components thereof may be implemented in hardware (e.g., in communications management circuitry). The hardware may include a processor, a DSP, a CPU, an ASIC, an FPGA or other programmable logic device, a microcontroller, discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory)

Additionally, or alternatively, in some examples, the communications manager 1120, the receiver 1110, the transmitter 1115, or various combinations or components thereof may be implemented in code (e.g., as communications management software or firmware) executed by a processor. If implemented in code executed by a processor, the functions of the communications manager 1120, the receiver 1110, the transmitter 1115, or various combinations or components thereof may be performed by a general-purpose processor, a DSP, a CPU, an ASIC, an FPGA, a microcontroller, or any combination of these or other programmable logic devices (e.g., configured as or otherwise supporting a means for performing the functions described in the present disclosure).

In some examples, the communications manager 1120 may be configured to perform various operations (e.g., receiving, obtaining, monitoring, outputting, transmitting) using or otherwise in cooperation with the receiver 1110, the transmitter 1115, or both. For example, the communications manager 1120 may receive information from the receiver 1110, send information to the transmitter 1115, or be integrated in combination with the receiver 1110, the transmitter 1115, or both to obtain information, output information, or perform various other operations as described herein.

The communications manager 1120 may support wireless communication at a network node in accordance with examples as disclosed herein. For example, the communications manager 1120 may be configured as or otherwise support a means for transmitting control signaling indicating a multi-wakeup signal configuration, the multi-wakeup signal configuration indicating a wakeup signal window, indicating a first wakeup signal occasion within the wakeup signal window that indicates whether to monitor an upcoming on duration of a DRX cycle, and indicating to monitor at least one second wakeup signal occasion within the wakeup signal window when a first wakeup signal is detected in the first wakeup signal occasion, the at least one second wakeup signal occasion indicating a start time of the upcoming on duration of the DRX cycle. The communications manager 1120 may be configured as or otherwise support a means for transmitting the first wakeup signal in the first wakeup signal occasion based on the multi-wakeup signal configuration. The communications manager 1120 may be configured as or otherwise support a means for transmitting a second wakeup signal in the at least one second wakeup signal occasion based on the multi-wakeup signal configuration.

By including or configuring the communications manager 1120 in accordance with examples as described herein, the device 1105 (e.g., a processor controlling or otherwise coupled with the receiver 1110, the transmitter 1115, the communications manager 1120, or a combination thereof) may support techniques for adaptive jitter indication via wakeup signals, which may reduce latency and reduce power consumption based on refraining from monitoring DRX on duration if no data is scheduled for reception during the DRX on duration.

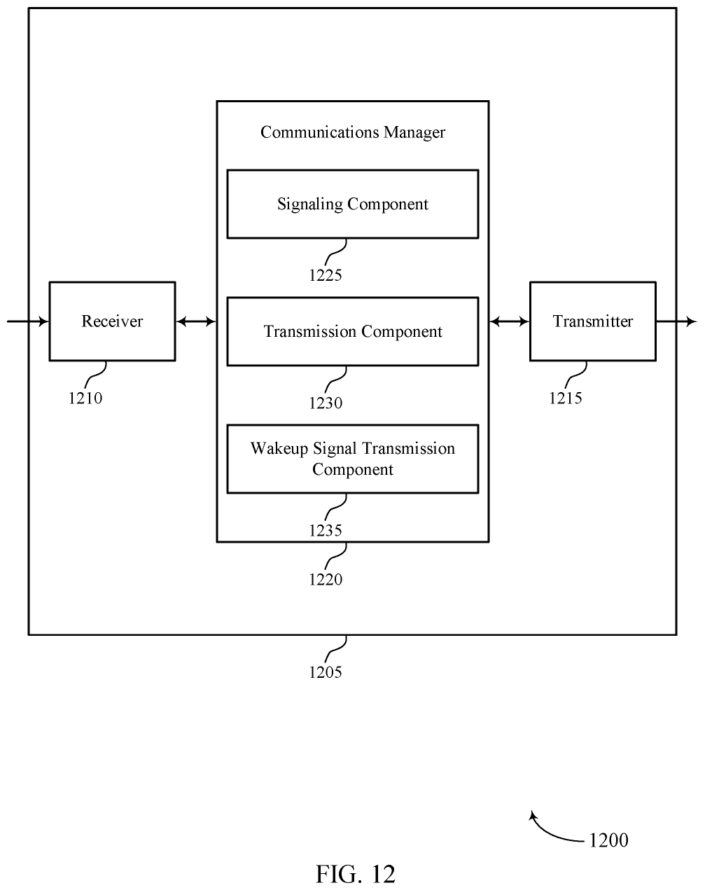

FIG. 12 shows a block diagram 1200 of a device 1205 that supports adaptive jitter indication via a wakeup signal in accordance with one or more aspects of the present disclosure. The device 1205 may be an example of aspects of a device 1105 or a network node 105 as described herein. The device 1205 may include a receiver 1210, a transmitter 1215, and a communications manager 1220. The device 1205 may also include a processor. Each of these components may be in communication with one another (e.g., via one or more buses).

The receiver 1210 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1205. In some examples, the receiver 1210 may support obtaining information by receiving signals via one or more antennas. Additionally, or alternatively, the receiver 1210 may support obtaining information by receiving signals via one or more wired (e.g., electrical, fiber optic) interfaces, wireless interfaces, or any combination thereof.

The transmitter 1215 may provide a means for outputting (e.g., transmitting, providing, conveying, sending) information generated by other components of the device 1205. For example, the transmitter 1215 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1215 may support outputting information by transmitting signals via one or more antennas. Additionally, or alternatively, the transmitter 1215 may support outputting information by transmitting signals via one or more wired (e.g., electrical, fiber optic) interfaces, wireless interfaces, or any combination thereof. In some examples, the transmitter 1215 and the receiver 1210 may be co-located in a transceiver, which may include or be coupled with a modem.

The device 1205, or various components thereof, may be an example of means for performing various aspects of adaptive jitter indication via a wakeup signal as described herein. For example, the communications manager 1220 may include a signaling component 1225, a transmission component 1230, a wakeup signal transmission component 1235, or any combination thereof. The communications manager 1220 may be an example of aspects of a communications manager 1120 as described herein. In some examples, the communications manager 1220, or various components thereof, may be configured to perform various operations (e.g., receiving, obtaining, monitoring, outputting, transmitting) using or otherwise in cooperation with the receiver 1210, the transmitter 1215, or both. For example, the communications manager 1220 may receive information from the receiver 1210, send information to the transmitter 1215, or be integrated in combination with the receiver 1210, the transmitter 1215, or both to obtain information, output information, or perform various other operations as described herein.

The communications manager 1220 may support wireless communication at a network node in accordance with examples as disclosed herein. The signaling component 1225 may be configured as or otherwise support a means for transmitting control signaling indicating a multi-wakeup signal configuration, the multi-wakeup signal configuration indicating a wakeup signal window, indicating a first wakeup signal occasion within the wakeup signal window that indicates whether to monitor an upcoming on duration of a DRX cycle, and indicating to monitor at least one second wakeup signal occasion within the wakeup signal window when a first wakeup signal is detected in the first wakeup signal occasion, the at least one second wakeup signal occasion indicating a start time of the upcoming on duration of the DRX cycle. The transmission component 1230 may be configured as or otherwise support a means for transmitting the first wakeup signal in the first wakeup signal occasion based on the multi-wakeup signal configuration. The wakeup signal transmission component 1235 may be configured as or otherwise support a means for transmitting a second wakeup signal in the at least one second wakeup signal occasion based on the multi-wakeup signal configuration.

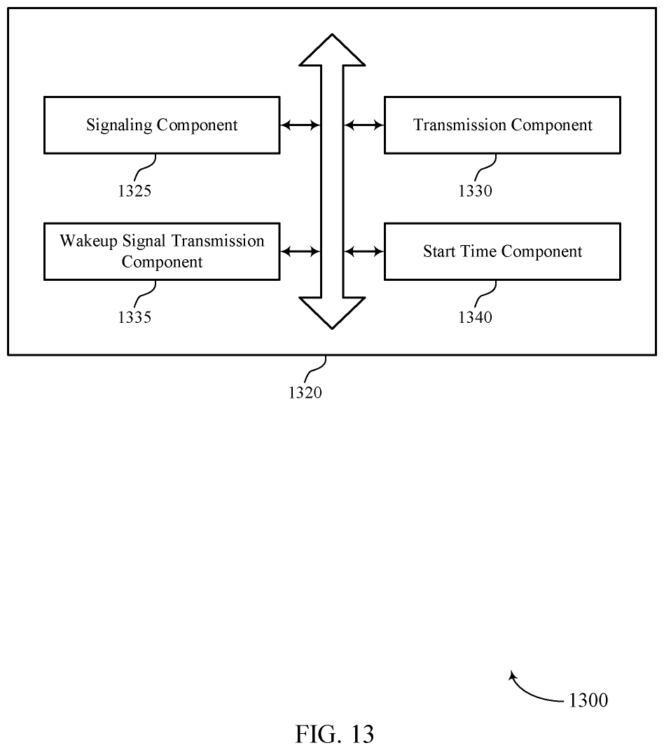

FIG. 13 shows a block diagram 1300 of a communications manager 1320 that supports adaptive jitter indication via a wakeup signal in accordance with one or more aspects of the present disclosure. The communications manager 1320 may be an example of aspects of a communications manager 1120, a communications manager 1220, or both, as described herein. The communications manager 1320, or various components thereof, may be an example of means for performing various aspects of adaptive jitter indication via a wakeup signal as described herein. For example, the communications manager 1320 may include a signaling component 1325, a transmission component 1330, a wakeup signal transmission component 1335, a start time component 1340, or any combination thereof. Each of these components may communicate, directly or indirectly, with one another (e.g., via one or more buses).

The communications manager 1320 may support wireless communication at a network node in accordance with examples as disclosed herein. The signaling component 1325 may be configured as or otherwise support a means for transmitting control signaling indicating a multi-wakeup signal configuration, the multi-wakeup signal configuration indicating a wakeup signal window, indicating a first wakeup signal occasion within the wakeup signal window that indicates whether to monitor an upcoming on duration of a DRX cycle, and indicating to monitor at least one second wakeup signal occasion within the wakeup signal window when a first wakeup signal is detected in the first wakeup signal occasion, the at least one second wakeup signal occasion indicating a start time of the upcoming on duration of the DRX cycle. The transmission component 1330 may be configured as or otherwise support a means for transmitting the first wakeup signal in the first wakeup signal occasion based on the multi-wakeup signal configuration. The wakeup signal transmission component 1335 may be configured as or otherwise support a means for transmitting a second wakeup signal in the at least one second wakeup signal occasion based on the multi-wakeup signal configuration.

In some examples, to support transmitting the second wakeup signal, the wakeup signal transmission component 1335 may be configured as or otherwise support a means for transmitting the second wakeup signal in the at least one second wakeup signal occasion based on transmitting the first wakeup signal in the first wakeup signal occasion.

In some examples, to support transmitting the second wakeup signal, the wakeup signal transmission component 1335 may be configured as or otherwise support a means for transmitting the second wakeup signal in the at least one second wakeup signal occasion, the second wakeup signal indicating that data that is scheduled to be transmitted to a UE within the upcoming on duration of the DRX cycle.

In some examples, the start time of the upcoming on duration of the DRX cycle is indicated in the second wakeup signal. In some examples, the start time of the upcoming on duration of the DRX cycle corresponds to a time offset with respect to the at least one second wakeup signal occasion.

In some examples, the first wakeup signal occasion and the at least one second wakeup signal occasion at least partially overlap in time, in frequency, or both. In some examples, one or more sequences are associated with the first wakeup signal, the second wakeup signal, or both. In some examples, one or more signaling types are associated with the first wakeup signal, the second wakeup signal, or both. In some examples, one or more resource allocations are associated with the first wakeup signal, the second wakeup signal, or both. In some examples, one or more modulations are associated with the first wakeup signal, the second wakeup signal, or both.

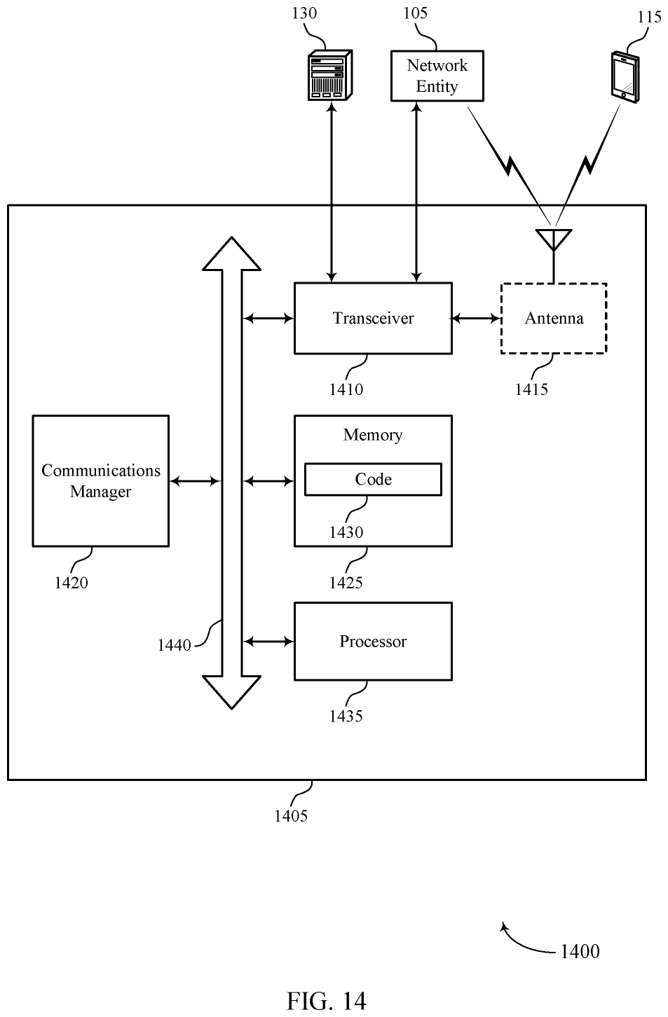

FIG. 14 shows a diagram of a system 1400 including a device 1405 that supports adaptive jitter indication via a wakeup signal in accordance with one or more aspects of the present disclosure. The device 1405 may be an example of or include the components of a device 1105, a device 1205, or a network node as described herein. The device 1405 may include components for bi-directional voice and data communications including components for transmitting and receiving communications, such as a communications manager 1420, a transceiver 1410, an antenna 1415, a memory 1425, code 1430, and a processor 1435. These components may be in electronic communication or otherwise coupled (e.g., operatively, communicatively, functionally, electronically, electrically) via one or more buses (e.g., a bus 1440).

The transceiver 1410 may support bi-directional communications via wired links, wireless links, or both as described herein. In some examples, the transceiver 1410 may include a wired transceiver and may communicate bi-directionally with another wired transceiver. Additionally, or alternatively, in some examples, the transceiver 1410 may include a wireless transceiver and may communicate bi-directionally with another wireless transceiver. In some examples, the device 1405 may include one or more antennas 1415, which may be capable of transmitting or receiving wireless transmissions (e.g., concurrently). The transceiver 1410 may also include a modem to modulate signals, to provide the modulated signals for transmission (e.g., by one or more antennas 1415, by a wired transmitter), to receive modulated signals (e.g., from one or more antennas 1415, from a wired receiver), and to demodulate signals. In some implementations, the transceiver 1410 may include one or more interfaces, such as one or more interfaces coupled with the one or more antennas 1415 that are configured to support various receiving or obtaining operations, or one or more interfaces coupled with the one or more antennas 1415 that are configured to support various transmitting or outputting operations, or a combination thereof. In some implementations, the transceiver 1410 may include or be configured for coupling with one or more processors or memory components that are operable to perform or support operations based on received or obtained information or signals, or to generate information or other signals for transmission or other outputting, or any combination thereof. In some implementations, the transceiver 1410, or the transceiver 1410 and the one or more antennas 1415, or the transceiver 1410 and the one or more antennas 1415 and one or more processors or memory components (for example, the processor 1435, or the memory 1425, or both), may be included in a chip or chip assembly that is installed in the device 1405. In some examples, the transceiver may be operable to support communications via one or more communications links (e.g., a communication link 125, a backhaul communication link 120, a midhaul communication link 162, a fronthaul communication link 168).

The memory 1425 may include RAM and ROM. The memory 1425 may store computer-readable, computer-executable code 1430 including instructions that, when executed by the processor 1435, cause the device 1405 to perform various functions described herein. The code 1430 may be stored in a non-transitory computer-readable medium such as system memory or another type of memory. In some cases, the code 1430 may not be directly executable by the processor 1435 but may cause a computer (e.g., when compiled and executed) to perform functions described herein. In some cases, the memory 1425 may contain, among other things, a BIOS which may control basic hardware or software operation such as the interaction with peripheral components or devices.

The processor 1435 may include an intelligent hardware device (e.g., a general-purpose processor, a DSP, an ASIC, a CPU, an FPGA, a microcontroller, a programmable logic device, discrete gate or transistor logic, a discrete hardware component, or any combination thereof). In some cases, the processor 1435 may be configured to operate a memory array using a memory controller. In some other cases, a memory controller may be integrated into the processor 1435. The processor 1435 may be configured to execute computer-readable instructions stored in a memory (e.g., the memory 1425) to cause the device 1405 to perform various functions (e.g., functions or tasks supporting adaptive jitter indication via a wakeup signal). For example, the device 1405 or a component of the device 1405 may include a processor 1435 and memory 1425 coupled with the processor 1435, the processor 1435 and memory 1425 configured to perform various functions described herein. The processor 1435 may be an example of a cloud-computing platform (e.g., one or more physical nodes and supporting software such as operating systems, virtual machines, or container instances) that may host the functions (e.g., by executing code 1430) to perform the functions of the device 1405. The processor 1435 may be any one or more suitable processors capable of executing scripts or instructions of one or more software programs stored in the device 1405 (such as within the memory 1425). In some implementations, the processor 1435 may be a component of a processing system. A processing system may generally refer to a system or series of machines or components that receives inputs and processes the inputs to produce a set of outputs (which may be passed to other systems or components of, for example, the device 1405). For example, a processing system of the device 1405 may refer to a system including the various other components or subcomponents of the device 1405, such as the processor 1435, or the transceiver 1410, or the communications manager 1420, or other components or combinations of components of the device 1405. The processing system of the device 1405 may interface with other components of the device 1405, and may process information received from other components (such as inputs or signals) or output information to other components. For example, a chip or modem of the device 1405 may include a processing system and one or more interfaces to output information, or to obtain information, or both. The one or more interfaces may be implemented as or otherwise include a first interface configured to output information and a second interface configured to obtain information, or a same interface configured to output information and to obtain information, among other implementations. In some implementations, the one or more interfaces may refer to an interface between the processing system of the chip or modem and a transmitter, such that the device 1405 may transmit information output from the chip or modem. Additionally, or alternatively, in some implementations, the one or more interfaces may refer to an interface between the processing system of the chip or modem and a receiver, such that the device 1405 may obtain information or signal inputs, and the information may be passed to the processing system. A person having ordinary skill in the art will readily recognize that a first interface also may obtain information or signal inputs, and a second interface also may output information or signal outputs.

In some examples, a bus 1440 may support communications of (e.g., within) a protocol layer of a protocol stack. In some examples, a bus 1440 may support communications associated with a logical channel of a protocol stack (e.g., between protocol layers of a protocol stack), which may include communications performed within a component of the device 1405, or between different components of the device 1405 that may be co-located or located in different locations (e.g., where the device 1405 may refer to a system in which one or more of the communications manager 1420, the transceiver 1410, the memory 1425, the code 1430, and the processor 1435 may be located in one of the different components or divided between different components).

In some examples, the communications manager 1420 may manage aspects of communications with a core network 130 (e.g., via one or more wired or wireless backhaul links). For example, the communications manager 1420 may manage the transfer of data communications for client devices, such as one or more UEs 115. In some examples, the communications manager 1420 may manage communications with other network entities 105, and may include a controller or scheduler for controlling communications with UEs 115 in cooperation with other network entities 105. In some examples, the communications manager 1420 may support an X2 interface within an LTE/LTE-A wireless communications network technology to provide communication between network entities 105.

The communications manager 1420 may support wireless communication at a network node in accordance with examples as disclosed herein. For example, the communications manager 1420 may be configured as or otherwise support a means for transmitting control signaling indicating a multi-wakeup signal configuration, the multi-wakeup signal configuration indicating a wakeup signal window, indicating a first wakeup signal occasion within the wakeup signal window that indicates whether to monitor an upcoming on duration of a DRX cycle, and indicating to monitor at least one second wakeup signal occasion within the wakeup signal window when a first wakeup signal is detected in the first wakeup signal occasion, the at least one second wakeup signal occasion indicating a start time of the upcoming on duration of the DRX cycle. The communications manager 1420 may be configured as or otherwise support a means for transmitting the first wakeup signal in the first wakeup signal occasion based on the multi-wakeup signal configuration. The communications manager 1420 may be configured as or otherwise support a means for transmitting a second wakeup signal in the at least one second wakeup signal occasion based on the multi-wakeup signal configuration.

By including or configuring the communications manager 1420 in accordance with examples as described herein, the device 1405 may support techniques for adaptive jitter indication via wakeup signals, which may reduce latency and reduce power consumption based on refraining from monitoring DRX on duration if no data is scheduled for reception during the DRX on duration.

In some examples, the communications manager 1420 may be configured to perform various operations (e.g., receiving, obtaining, monitoring, outputting, transmitting) using or otherwise in cooperation with the transceiver 1410, the one or more antennas 1415 (e.g., where applicable), or any combination thereof. Although the communications manager 1420 is illustrated as a separate component, in some examples, one or more functions described with reference to the communications manager 1420 may be supported by or performed by the transceiver 1410, the processor 1435, the memory 1425, the code 1430, or any combination thereof. For example, the code 1430 may include instructions executable by the processor 1435 to cause the device 1405 to perform various aspects of adaptive jitter indication via a wakeup signal as described herein, or the processor 1435 and the memory 1425 may be otherwise configured to perform or support such operations.

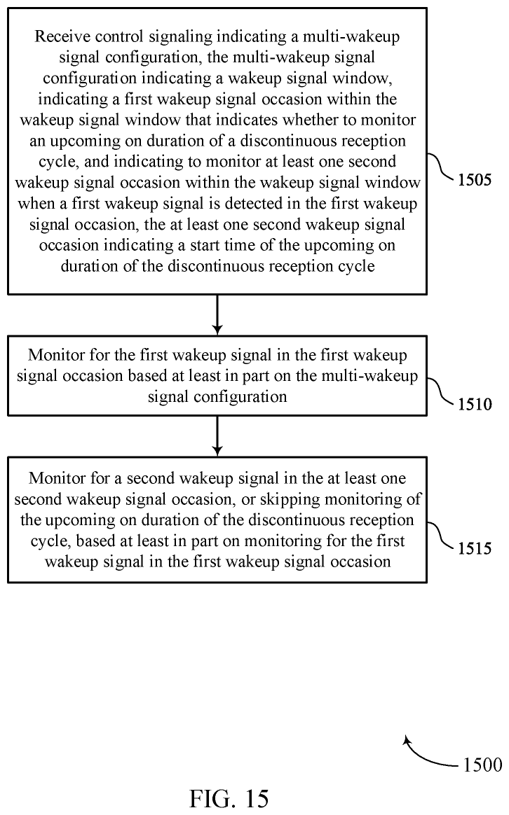

FIG. 15 shows a flowchart illustrating a method 1500 that supports adaptive jitter indication via a wakeup signal in accordance with one or more aspects of the present disclosure. The operations of the method 1500 may be implemented by a UE or its components as described herein. For example, the operations of the method 1500 may be performed by a UE 115 as described with reference to FIGS. 1 through 10. In some examples, a UE may execute a set of instructions to control the functional elements of the UE to perform the described functions. Additionally, or alternatively, the UE may perform aspects of the described functions using special-purpose hardware.

At 1505, the method may include receiving control signaling indicating a multi-wakeup signal configuration, the multi-wakeup signal configuration indicating a wakeup signal window, indicating a first wakeup signal occasion within the wakeup signal window that indicates whether to monitor an upcoming on duration of a DRX cycle, and indicating to monitor at least one second wakeup signal occasion within the wakeup signal window when a first wakeup signal is detected in the first wakeup signal occasion, the at least one second wakeup signal occasion indicating a start time of the upcoming on duration of the DRX cycle. The operations of 1505 may be performed in accordance with examples as disclosed herein. In some examples, aspects of the operations of 1505 may be performed by a control signaling component 925 as described with reference to FIG. 9.

At 1510, the method may include monitoring for the first wakeup signal in the first wakeup signal occasion based on the multi-wakeup signal configuration. The operations of 1510 may be performed in accordance with examples as disclosed herein. In some examples, aspects of the operations of 1510 may be performed by a wakeup signal component 930 as described with reference to FIG. 9.

At 1515, the method may include monitoring for a second wakeup signal in the at least one second wakeup signal occasion, or skipping monitoring of the upcoming on duration of the DRX cycle, based on monitoring for the first wakeup signal in the first wakeup signal occasion. The operations of 1515 may be performed in accordance with examples as disclosed herein. In some examples, aspects of the operations of 1515 may be performed by a wakeup signal monitoring component 935 as described with reference to FIG. 9.

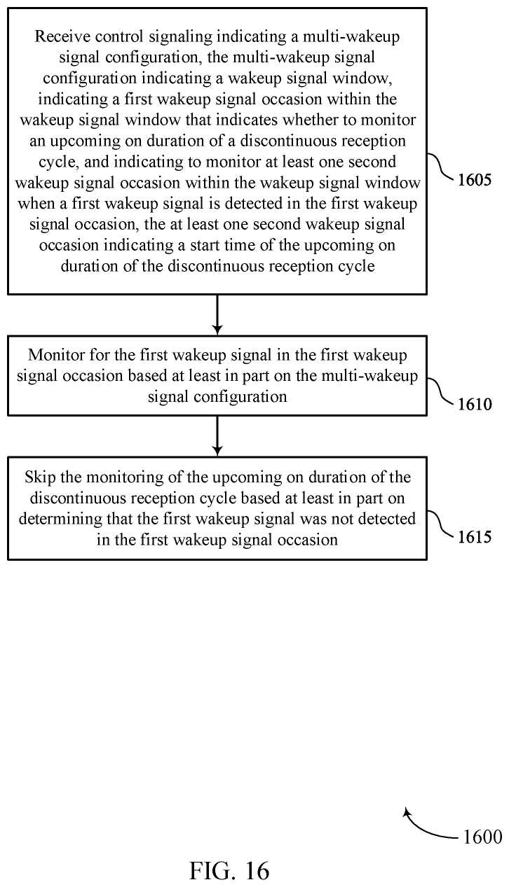

FIG. 16 shows a flowchart illustrating a method 1600 that supports adaptive jitter indication via a wakeup signal in accordance with one or more aspects of the present disclosure. The operations of the method 1600 may be implemented by a UE or its components as described herein. For example, the operations of the method 1600 may be performed by a UE 115 as described with reference to FIGS. 1 through 10. In some examples, a UE may execute a set of instructions to control the functional elements of the UE to perform the described functions. Additionally, or alternatively, the UE may perform aspects of the described functions using special-purpose hardware.

At 1605, the method may include receiving control signaling indicating a multi-wakeup signal configuration, the multi-wakeup signal configuration indicating a wakeup signal window, indicating a first wakeup signal occasion within the wakeup signal window that indicates whether to monitor an upcoming on duration of a DRX cycle, and indicating to monitor at least one second wakeup signal occasion within the wakeup signal window when a first wakeup signal is detected in the first wakeup signal occasion, the at least one second wakeup signal occasion indicating a start time of the upcoming on duration of the DRX cycle. The operations of 1605 may be performed in accordance with examples as disclosed herein. In some examples, aspects of the operations of 1605 may be performed by a control signaling component 925 as described with reference to FIG. 9.

At 1610, the method may include monitoring for the first wakeup signal in the first wakeup signal occasion based on the multi-wakeup signal configuration. The operations of 1610 may be performed in accordance with examples as disclosed herein. In some examples, aspects of the operations of 1610 may be performed by a wakeup signal component 930 as described with reference to FIG. 9.

At 1615, the method may include skipping the monitoring of the upcoming on duration of the DRX cycle based on determining that the first wakeup signal was not detected in the first wakeup signal occasion. The operations of 1615 may be performed in accordance with examples as disclosed herein. In some examples, aspects of the operations of 1615 may be performed by a DRX component 955 as described with reference to FIG. 9.

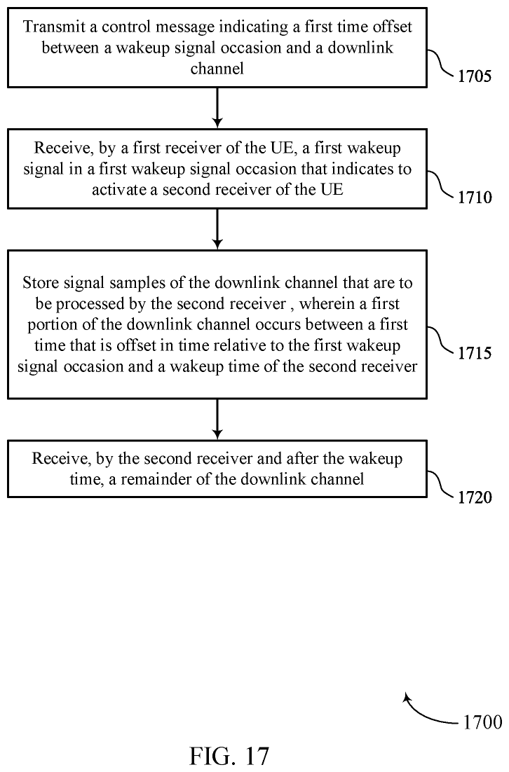

FIG. 17 shows a flowchart illustrating a method 1700 that supports adaptive jitter indication via a wakeup signal in accordance with one or more aspects of the present disclosure. The operations of the method 1700 may be implemented by a UE or its components as described herein. For example, the operations of the method 1700 may be performed by a UE 115 as described with reference to FIGS. 1 through 10. In some examples, a UE may execute a set of instructions to control the functional elements of the UE to perform the described functions. Additionally, or alternatively, the UE may perform aspects of the described functions using special-purpose hardware.

At 1705, the method may include transmitting a control message indicating a first time offset between a wakeup signal occasion and a downlink channel. The operations of 1705 may be performed in accordance with examples as disclosed herein. In some examples, aspects of the operations of 1705 may be performed by a time offset component 940 as described with reference to FIG. 9.

At 1710, the method may include receiving, by a first receiver of the UE, a first wakeup signal in a first wakeup signal occasion that indicates to activate a second receiver of the UE. The operations of 1710 may be performed in accordance with examples as disclosed herein. In some examples, aspects of the operations of 1710 may be performed by a wakeup signal component 930 as described with reference to FIG. 9.

At 1715, the method may include storing signal samples of the downlink channel that are to be processed by the second receiver, where a first portion of the downlink channel occurs between a first time that is offset in time relative to the first wakeup signal occasion and a wakeup time of the second receiver. The operations of 1715 may be performed in accordance with examples as disclosed herein. In some examples, aspects of the operations of 1715 may be performed by a storage component 945 as described with reference to FIG. 9.

At 1720, the method may include receiving, by the second receiver and after the wakeup time, a remainder of the downlink channel. The operations of 1720 may be performed in accordance with examples as disclosed herein. In some examples, aspects of the operations of 1720 may be performed by a downlink reception component 950 as described with reference to FIG. 9.

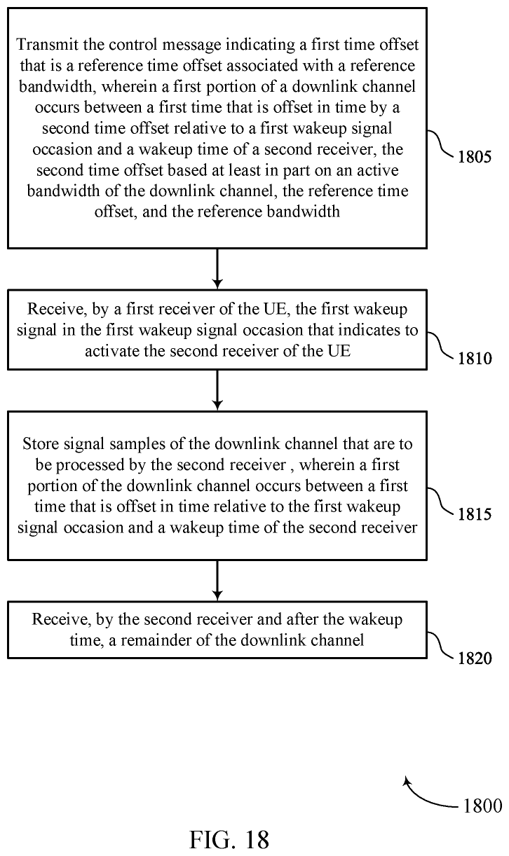

FIG. 18 shows a flowchart illustrating a method 1800 that supports adaptive jitter indication via a wakeup signal in accordance with one or more aspects of the present disclosure. The operations of the method 1800 may be implemented by a UE or its components as described herein. For example, the operations of the method 1800 may be performed by a UE 115 as described with reference to FIGS. 1 through 10. In some examples, a UE may execute a set of instructions to control the functional elements of the UE to perform the described functions. Additionally, or alternatively, the UE may perform aspects of the described functions using special-purpose hardware.

At 1805, the method may include transmitting the control message indicating a first time offset that is a reference time offset associated with a reference bandwidth, where a first portion of a downlink channel occurs between a first time that is offset in time by a second time offset relative to a first wakeup signal occasion and a wakeup time of a second receiver, the second time offset based on an active bandwidth of the downlink channel, the reference time offset, and the reference bandwidth. The operations of 1805 may be performed in accordance with examples as disclosed herein. In some examples, aspects of the operations of 1805 may be performed by a time offset component 940 as described with reference to FIG. 9.

At 1810, the method may include receiving, by a first receiver of the UE, the first wakeup signal in the first wakeup signal occasion that indicates to activate the second receiver of the UE. The operations of 1810 may be performed in accordance with examples as disclosed herein. In some examples, aspects of the operations of 1810 may be performed by a wakeup signal component 930 as described with reference to FIG. 9.

At 1815, the method may include storing signal samples of the downlink channel that are to be processed by the second receiver, where a first portion of the downlink channel occurs between a first time that is offset in time relative to the first wakeup signal occasion and a wakeup time of the second receiver. The operations of 1815 may be performed in accordance with examples as disclosed herein. In some examples, aspects of the operations of 1815 may be performed by a storage component 945 as described with reference to FIG. 9.

At 1820, the method may include receiving, by the second receiver and after the wakeup time, a remainder of the downlink channel. The operations of 1820 may be performed in accordance with examples as disclosed herein. In some examples, aspects of the operations of 1820 may be performed by a downlink reception component 950 as described with reference to FIG. 9.

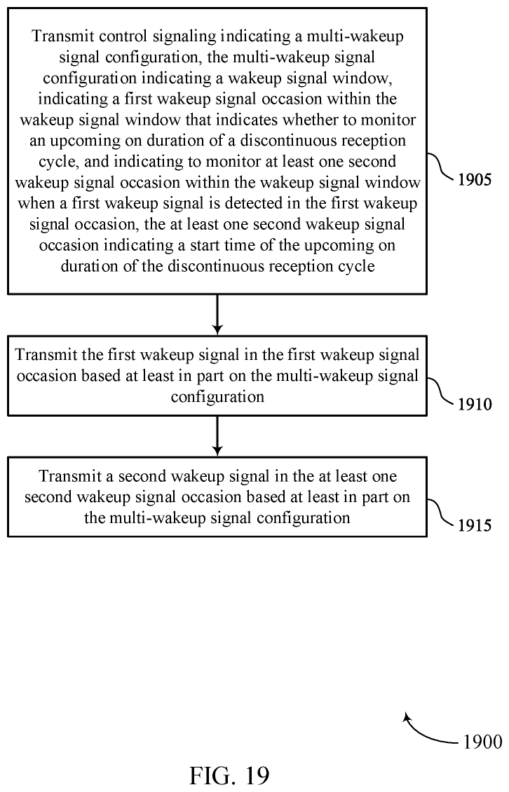

FIG. 19 shows a flowchart illustrating a method 1900 that supports adaptive jitter indication via a wakeup signal in accordance with one or more aspects of the present disclosure. The operations of the method 1900 may be implemented by a network node or its components as described herein. For example, the operations of the method 1900 may be performed by a network node as described with reference to FIGS. 1 through 6 and 11 through 14. In some examples, a network node may execute a set of instructions to control the functional elements of the network node to perform the described functions. Additionally, or alternatively, the network node may perform aspects of the described functions using special-purpose hardware.

At 1905, the method may include transmitting control signaling indicating a multi-wakeup signal configuration, the multi-wakeup signal configuration indicating a wakeup signal window, indicating a first wakeup signal occasion within the wakeup signal window that indicates whether to monitor an upcoming on duration of a DRX cycle, and indicating to monitor at least one second wakeup signal occasion within the wakeup signal window when a first wakeup signal is detected in the first wakeup signal occasion, the at least one second wakeup signal occasion indicating a start time of the upcoming on duration of the DRX cycle. The operations of 1905 may be performed in accordance with examples as disclosed herein. In some examples, aspects of the operations of 1905 may be performed by a signaling component 1325 as described with reference to FIG. 13.

At 1910, the method may include transmitting the first wakeup signal in the first wakeup signal occasion based on the multi-wakeup signal configuration. The operations of 1910 may be performed in accordance with examples as disclosed herein. In some examples, aspects of the operations of 1910 may be performed by a transmission component 1330 as described with reference to FIG. 13.

At 1915, the method may include transmitting a second wakeup signal in the at least one second wakeup signal occasion based on the multi-wakeup signal configuration. The operations of 1915 may be performed in accordance with examples as disclosed herein. In some examples, aspects of the operations of 1915 may be performed by a wakeup signal transmission component 1335 as described with reference to FIG. 13.

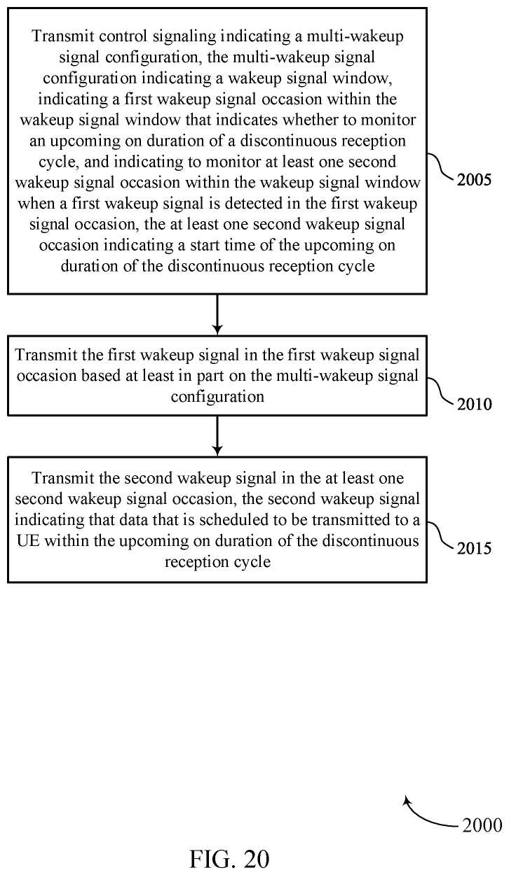

FIG. 20 shows a flowchart illustrating a method 2000 that supports adaptive jitter indication via a wakeup signal in accordance with one or more aspects of the present disclosure. The operations of the method 2000 may be implemented by a network node or its components as described herein. For example, the operations of the method 2000 may be performed by a network node as described with reference to FIGS. 1 through 6 and 11 through 14. In some examples, a network node may execute a set of instructions to control the functional elements of the network node to perform the described functions. Additionally, or alternatively, the network node may perform aspects of the described functions using special-purpose hardware.

At 2005, the method may include transmitting control signaling indicating a multi-wakeup signal configuration, the multi-wakeup signal configuration indicating a wakeup signal window, indicating a first wakeup signal occasion within the wakeup signal window that indicates whether to monitor an upcoming on duration of a DRX cycle, and indicating to monitor at least one second wakeup signal occasion within the wakeup signal window when a first wakeup signal is detected in the first wakeup signal occasion, the at least one second wakeup signal occasion indicating a start time of the upcoming on duration of the DRX cycle. The operations of 2005 may be performed in accordance with examples as disclosed herein. In some examples, aspects of the operations of 2005 may be performed by a signaling component 1325 as described with reference to FIG. 13.

At 2010, the method may include transmitting the first wakeup signal in the first wakeup signal occasion based on the multi-wakeup signal configuration. The operations of 2010 may be performed in accordance with examples as disclosed herein. In some examples, aspects of the operations of 2010 may be performed by a transmission component 1330 as described with reference to FIG. 13.

At 2015, the method may include transmitting the second wakeup signal in the at least one second wakeup signal occasion, the second wakeup signal indicating that data that is scheduled to be transmitted to a UE within the upcoming on duration of the DRX cycle. The operations of 2015 may be performed in accordance with examples as disclosed herein. In some examples, aspects of the operations of 2015 may be performed by a wakeup signal transmission component 1335 as described with reference to FIG. 13.

The following provides an overview of aspects of the present disclosure:

Aspect 1: A method for wireless communication at a UE, comprising: receiving control signaling indicating a multi-wakeup signal configuration, the multi-wakeup signal configuration indicating a wakeup signal window, indicating a first wakeup signal occasion within the wakeup signal window that indicates whether to monitor an upcoming on duration of a DRX cycle, and indicating to monitor at least one second wakeup signal occasion within the wakeup signal window when a first wakeup signal is detected in the first wakeup signal occasion, the at least one second wakeup signal occasion indicating a start time of the upcoming on duration of the DRX cycle; monitoring for the first wakeup signal in the first wakeup signal occasion based at least in part on the multi-wakeup signal configuration; and monitoring for a second wakeup signal in the at least one second wakeup signal occasion, or skipping monitoring of the upcoming on duration of the DRX cycle, based at least in part on monitoring for the first wakeup signal in the first wakeup signal occasion.

Aspect 2: The method of aspect 1, further comprising: skipping the monitoring of the upcoming on duration of the DRX cycle based at least in part on determining that the first wakeup signal was not detected in the first wakeup signal occasion.

Aspect 3: The method of any of aspects 1 through 2, further comprising: monitoring for the second wakeup signal in the at least one second wakeup signal occasion based at least in part on detecting the first wakeup signal in the first wakeup signal occasion.

Aspect 4: The method of any of aspects 1 through 3, further comprising: receiving the second wakeup signal in the at least one second wakeup signal occasion, the second wakeup signal indicating that data is scheduled to be transmitted to the UE within the upcoming on duration of the DRX cycle.

Aspect 5: The method of any of aspects 1 through 4, further comprising: skipping the monitoring for the second wakeup signal in one or more remaining second wakeup signal occasions in the wakeup signal window based at least in part on detecting the second wakeup signal in the at least one second wakeup signal occasion.

Aspect 6: The method of any of aspects 1 through 5, further comprising: monitoring the upcoming on duration of the DRX cycle based at least in part on the start time of the upcoming on duration of the DRX cycle indicated in the second wakeup signal.

Aspect 7: The method of any of aspects 1 through 6, further comprising: monitoring the upcoming on duration of the DRX cycle at the start time of the upcoming on duration of the DRX cycle corresponding to a time offset with respect to the at least one second wakeup signal occasion in which the UE detects the second wakeup signal.

Aspect 8: The method of any of aspects 1 through 7, wherein the first wakeup signal occasion and the at least one second wakeup signal occasion at least partially overlap in time, in frequency, or both.

Aspect 9: The method of any of aspects 1 through 8, wherein one or more sequences are associated with the first wakeup signal, the second wakeup signal, or both.

Aspect 10: The method of any of aspects 1 through 9, wherein one or more signaling types are associated with the first wakeup signal, the second wakeup signal, or both.

Aspect 11: The method of any of aspects 1 through 10, wherein one or more resource allocations are associated with the first wakeup signal, the second wakeup signal, or both.

Aspect 12: The method of any of aspects 1 through 11, wherein one or more modulations are associated with the first wakeup signal, the second wakeup signal, or both.

Aspect 13: A method for wireless communication at a UE, comprising: transmitting a control message indicating a first time offset between a wakeup signal occasion and a downlink channel; receiving, by a first receiver of the UE, a first wakeup signal in a first wakeup signal occasion that indicates to activate a second receiver of the UE; storing signal samples of the downlink channel that are to be processed by the second receiver, wherein a first portion of the downlink channel occurs between a first time that is offset in time relative to the first wakeup signal occasion and a wakeup time of the second receiver; and receiving, by the second receiver and after the wakeup time, a remainder of the downlink channel.

Aspect 14: The method of aspect 13, wherein transmitting the control message comprises: transmitting the control message indicating the first time offset that is a reference time offset associated with a reference bandwidth, wherein the first portion of the downlink channel occurs between the first time that is offset in time by a second time offset relative to the first wakeup signal occasion and the wakeup time of the second receiver, the second time offset based at least in part on an active bandwidth of the downlink channel, the reference time offset, and the reference bandwidth.

Aspect 15: The method of any of aspects 13 through 14, wherein transmitting the control message comprises: transmitting the control message indicating a plurality of time offsets associated with respective reference bandwidths, the plurality of time offsets comprising the first time offset, wherein the first portion of the downlink channel occurs between the first time that is offset in time by a second time offset relative to the first wakeup signal occasion and the wakeup time of the second receiver, wherein the second time offset corresponds to one of the plurality of time offsets.

Aspect 16: The method of aspect 15, wherein the second time offset corresponds to a smallest reference bandwidth of the respective reference bandwidths that is larger than an active bandwidth of the downlink channel.

Aspect 17: The method of any of aspects 13 through 16, wherein transmitting the control message comprises: transmitting the control message indicating the time offset that corresponds to an active bandwidth of the downlink channel.

Aspect 18: The method of any of aspects 13 through 17, wherein the control message comprises UE capability signaling or UAI.

Aspect 19: A method for wireless communication at a network node, comprising: transmitting control signaling indicating a multi-wakeup signal configuration, the multi-wakeup signal configuration indicating a wakeup signal window, indicating a first wakeup signal occasion within the wakeup signal window that indicates whether to monitor an upcoming on duration of a DRX cycle, and indicating to monitor at least one second wakeup signal occasion within the wakeup signal window when a first wakeup signal is detected in the first wakeup signal occasion, the at least one second wakeup signal occasion indicating a start time of the upcoming on duration of the DRX cycle; transmitting the first wakeup signal in the first wakeup signal occasion based at least in part on the multi-wakeup signal configuration; and transmitting a second wakeup signal in the at least one second wakeup signal occasion based at least in part on the multi-wakeup signal configuration.

Aspect 20: The method of aspect 19, wherein transmitting the second wakeup signal comprises: transmitting the second wakeup signal in the at least one second wakeup signal occasion based at least in part on transmitting the first wakeup signal in the first wakeup signal occasion.

Aspect 21: The method of any of aspects 19 through 20, wherein transmitting the second wakeup signal comprises: transmitting the second wakeup signal in the at least one second wakeup signal occasion, the second wakeup signal indicating that data that is scheduled to be transmitted to a UE within the upcoming on duration of the DRX cycle.

Aspect 22: The method of any of aspects 19 through 21, wherein the start time of the upcoming on duration of the DRX cycle is indicated in the second wakeup signal.

Aspect 23: The method of any of aspects 19 through 22, wherein the start time of the upcoming on duration of the DRX cycle corresponds to a time offset with respect to the at least one second wakeup signal occasion.

Aspect 24: The method of any of aspects 19 through 23, wherein the first wakeup signal occasion and the at least one second wakeup signal occasion at least partially overlap in time, in frequency, or both.

Aspect 25: The method of any of aspects 19 through 24, wherein one or more sequences are associated with the first wakeup signal, the second wakeup signal, or both.

Aspect 26: The method of any of aspects 19 through 25, wherein one or more signaling types are associated with the first wakeup signal, the second wakeup signal, or both.

Aspect 27: The method of any of aspects 19 through 26, wherein one or more resource allocations are associated with the first wakeup signal, the second wakeup signal, or both.

Aspect 28: The method of any of aspects 19 through 27, wherein one or more modulations are associated with the first wakeup signal, the second wakeup signal, or both.

Aspect 29: An apparatus for wireless communication at a UE, comprising a processor; memory coupled with the processor; and instructions stored in the memory and executable by the processor to cause the apparatus to perform a method of any of aspects 1 through 12.

Aspect 30: An apparatus for wireless communication at a UE, comprising at least one means for performing a method of any of aspects 1 through 12.

Aspect 31: A non-transitory computer-readable medium storing code for wireless communication at a UE, the code comprising instructions executable by a processor to perform a method of any of aspects 1 through 12.

Aspect 32: An apparatus for wireless communication at a UE, comprising a processor; memory coupled with the processor; and instructions stored in the memory and executable by the processor to cause the apparatus to perform a method of any of aspects 13 through 18.

Aspect 33: An apparatus for wireless communication at a UE, comprising at least one means for performing a method of any of aspects 13 through 18.

Aspect 34: A non-transitory computer-readable medium storing code for wireless communication at a UE, the code comprising instructions executable by a processor to perform a method of any of aspects 13 through 18.

Aspect 35: An apparatus for wireless communication at a network node, comprising a processor; memory coupled with the processor; and instructions stored in the memory and executable by the processor to cause the apparatus to perform a method of any of aspects 19 through 28.

Aspect 36: An apparatus for wireless communication at a network node, comprising at least one means for performing a method of any of aspects 19 through 28.

Aspect 37: A non-transitory computer-readable medium storing code for wireless communication at a network node, the code comprising instructions executable by a processor to perform a method of any of aspects 19 through 28.

It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc. Disks may reproduce data magnetically, and discs may reproduce data optically using lasers. Combinations of the above are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.” Also, as used herein, the phrase “a set” shall be construed as including the possibility of a set with one member. That is, the phrase “a set” shall be construed in the same manner as “one or more.”

The term “determine” or “determining” encompasses a variety of actions and, therefore, “determining” can include calculating, computing, processing, deriving, investigating, looking up (such as via looking up in a table, a database or another data structure), ascertaining and the like. Also, “determining” can include receiving (e.g., receiving information), accessing (e.g., accessing data stored in memory) and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. An apparatus for wireless communication at a user equipment (UE), comprising:
a processor;
memory coupled with the processor; and
instructions stored in the memory and executable by the processor to cause the apparatus to:
receive control signaling indicating a multi-wakeup signal configuration, the multi-wakeup signal configuration indicating a wakeup signal window, indicating a first wakeup signal occasion within the wakeup signal window that indicates whether to monitor an upcoming on duration of a discontinuous reception cycle, and indicating to monitor at least one second wakeup signal occasion within the wakeup signal window when a first wakeup signal is detected in the first wakeup signal occasion, the at least one second wakeup signal occasion indicating a start time of the upcoming on duration of the discontinuous reception cycle;
monitor for the first wakeup signal in the first wakeup signal occasion based at least in part on the multi-wakeup signal configuration; and
monitor for a second wakeup signal in the at least one second wakeup signal occasion, or skipping monitoring of the upcoming on duration of the discontinuous reception cycle, based at least in part on monitoring for the first wakeup signal in the first wakeup signal occasion.

2. The apparatus of claim 1, wherein the instructions are further executable by the processor to cause the apparatus to:
skip the monitoring of the upcoming on duration of the discontinuous reception cycle based at least in part on determining that the first wakeup signal was not detected in the first wakeup signal occasion.

3. The apparatus of claim 1, wherein the instructions are further executable by the processor to cause the apparatus to:
monitor for the second wakeup signal in the at least one second wakeup signal occasion based at least in part on detecting the first wakeup signal in the first wakeup signal occasion.

4. The apparatus of claim 1, wherein the instructions are further executable by the processor to cause the apparatus to:
receive the second wakeup signal in the at least one second wakeup signal occasion, the second wakeup signal indicating that data is scheduled to be transmitted to the UE within the upcoming on duration of the discontinuous reception cycle.

5. The apparatus of claim 1, wherein the instructions are further executable by the processor to cause the apparatus to:
skip the monitoring for the second wakeup signal in one or more remaining second wakeup signal occasions in the wakeup signal window based at least in part on detecting the second wakeup signal in the at least one second wakeup signal occasion.

6. The apparatus of claim 1, wherein the instructions are further executable by the processor to cause the apparatus to:
monitor the upcoming on duration of the discontinuous reception cycle based at least in part on the start time of the upcoming on duration of the discontinuous reception cycle indicated in the second wakeup signal.

7. The apparatus of claim 1, wherein the instructions are further executable by the processor to cause the apparatus to:
monitor the upcoming on duration of the discontinuous reception cycle at the start time of the upcoming on duration of the discontinuous reception cycle corresponding to a time offset with respect to the at least one second wakeup signal occasion in which the UE detects the second wakeup signal.

8. The apparatus of claim 1, wherein:
the first wakeup signal occasion and the at least one second wakeup signal occasion at least partially overlap in time, in frequency, or both.

9. The apparatus of claim 1, wherein one or more sequences are associated with the first wakeup signal, the second wakeup signal, or both.

10. The apparatus of claim 1, wherein one or more signaling types are associated with the first wakeup signal, the second wakeup signal, or both.

11. The apparatus of claim 1, wherein one or more resource allocations are associated with the first wakeup signal, the second wakeup signal, or both.

12. The apparatus of claim 1, wherein one or more modulations are associated with the first wakeup signal, the second wakeup signal, or both.

13. An apparatus for wireless communication at a user equipment (UE), comprising:
a processor;
memory coupled with the processor; and
instructions stored in the memory and executable by the processor to cause the apparatus to:
transmit a control message indicating a first time offset between a wakeup signal occasion and a downlink channel;
receive, by a first receiver of the UE, a first wakeup signal in a first wakeup signal occasion that indicates to activate a second receiver of the UE;
store signal samples of the downlink channel that are to be processed by the second receiver, wherein a first portion of the downlink channel occurs between a first time that is offset in time relative to the first wakeup signal occasion and a wakeup time of the second receiver; and
receive, by the second receiver and after the wakeup time, a remainder of the downlink channel.

14. The apparatus of claim 13, wherein the instructions to transmit the control message are executable by the processor to cause the apparatus to:
transmit the control message indicating the first time offset that is a reference time offset associated with a reference bandwidth, wherein the first portion of the downlink channel occurs between the first time that is offset in time by a second time offset relative to the first wakeup signal occasion and the wakeup time of the second receiver, the second time offset based at least in part on an active bandwidth of the downlink channel, the reference time offset, and the reference bandwidth.

15. The apparatus of claim 13, wherein the instructions to transmit the control message are executable by the processor to cause the apparatus to:
transmit the control message indicating a plurality of time offsets associated with respective reference bandwidths, the plurality of time offsets comprising the first time offset, wherein the first portion of the downlink channel occurs between the first time that is offset in time by a second time offset relative to the first wakeup signal occasion and the wakeup time of the second receiver, wherein the second time offset corresponds to one of the plurality of time offsets.

16. The apparatus of claim 15, wherein the second time offset corresponds to a smallest reference bandwidth of the respective reference bandwidths that is larger than an active bandwidth of the downlink channel.

17. The apparatus of claim 13, wherein the instructions to transmit the control message are executable by the processor to cause the apparatus to:
transmit the control message indicating the time offset that corresponds to an active bandwidth of the downlink channel.

18. The apparatus of claim 13, wherein:
the control message comprises UE capability signaling or UE assistance information.

19. An apparatus for wireless communication at a network node, comprising:
a processor;
memory coupled with the processor; and
instructions stored in the memory and executable by the processor to cause the apparatus to:
transmit control signaling indicating a multi-wakeup signal configuration, the multi-wakeup signal configuration indicating a wakeup signal window, indicating a first wakeup signal occasion within the wakeup signal window that indicates whether to monitor an upcoming on duration of a discontinuous reception cycle, and indicating to monitor at least one second wakeup signal occasion within the wakeup signal window when a first wakeup signal is detected in the first wakeup signal occasion, the at least one second wakeup signal occasion indicating a start time of the upcoming on duration of the discontinuous reception cycle;
transmit the first wakeup signal in the first wakeup signal occasion based at least in part on the multi-wakeup signal configuration; and
transmit a second wakeup signal in the at least one second wakeup signal occasion based at least in part on the multi-wakeup signal configuration.

20. The apparatus of claim 19, wherein the instructions to transmit the second wakeup signal are executable by the processor to cause the apparatus to:
transmit the second wakeup signal in the at least one second wakeup signal occasion based at least in part on transmitting the first wakeup signal in the first wakeup signal occasion.

21. The apparatus of claim 19, wherein the instructions to transmit the second wakeup signal are executable by the processor to cause the apparatus to:
transmit the second wakeup signal in the at least one second wakeup signal occasion, the second wakeup signal indicating that data that is scheduled to be transmitted to a user equipment (UE) within the upcoming on duration of the discontinuous reception cycle.

22. The apparatus of claim 19, wherein the start time of the upcoming on duration of the discontinuous reception cycle is indicated in the second wakeup signal.

23. The apparatus of claim 19, wherein the start time of the upcoming on duration of the discontinuous reception cycle corresponds to a time offset with respect to the at least one second wakeup signal occasion.

24. The apparatus of claim 19, wherein:
the first wakeup signal occasion and the at least one second wakeup signal occasion at least partially overlap in time, in frequency, or both.

25. The apparatus of claim 19, wherein one or more sequences are associated with the first wakeup signal, the second wakeup signal, or both.

26. The apparatus of claim 19, wherein one or more signaling types are associated with the first wakeup signal, the second wakeup signal, or both.

27. The apparatus of claim 19, wherein one or more resource allocations are associated with the first wakeup signal, the second wakeup signal, or both.

28. The apparatus of claim 19, wherein one or more modulations are associated with the first wakeup signal, the second wakeup signal, or both.

29. A method for wireless communication at a user equipment (UE), comprising:
receiving control signaling indicating a multi-wakeup signal configuration, the multi-wakeup signal configuration indicating a wakeup signal window, indicating a first wakeup signal occasion within the wakeup signal window that indicates whether to monitor an upcoming on duration of a discontinuous reception cycle, and indicating to monitor at least one second wakeup signal occasion within the wakeup signal window when a first wakeup signal is detected in the first wakeup signal occasion, the at least one second wakeup signal occasion indicating a start time of the upcoming on duration of the discontinuous reception cycle;
monitoring for the first wakeup signal in the first wakeup signal occasion based at least in part on the multi-wakeup signal configuration; and
monitoring for a second wakeup signal in the at least one second wakeup signal occasion, or skipping monitoring of the upcoming on duration of the discontinuous reception cycle, based at least in part on monitoring for the first wakeup signal in the first wakeup signal occasion.

30. The method of claim 29, further comprising:
skipping the monitoring of the upcoming on duration of the discontinuous reception cycle based at least in part on determining that the first wakeup signal was not detected in the first wakeup signal occasion.
